(19) United States
(12) Patent Application Publication
(10) Pub. No.: US 2025/0199463 A1
(43) Pub. Date: Jun. 19, 2025

(54) PROCESS CARTRIDGE AND ELECTROPHOTOGRAPHIC APPARATUS

(71) Applicant: CANON KABUSHIKI KAISHA, Tokyo (JP)

(72) Inventors: KANAME WATARIGUCHI, Tokyo (JP); CHIHARU AKIYAMA, Shizuoka (JP); TAICHI SATO, Shizuoka (JP); NAO HIGUCHI, Shizuoka (JP); TSUTOMU NISHIDA, Shizuoka (JP)

(21) Appl. No.: 18/980,504

(22) Filed: Dec. 13, 2024

(30) Foreign Application Priority Data
Dec. 15, 2023 (JP) 2023-212292

(51) Int. Cl. G03G 21/18

(52) U.S. Cl. CPC G03G 21/1814; G03G 21/1828; G03G 21/1857

(57) ABSTRACT

A process cartridge being detachably attachable onto a main body of an electrophotographic apparatus, the process cartridge including an electrophotographic photosensitive member, a developing roller configured to develop an electrostatic latent image formed on the electrophotographic photosensitive member, and a toner-supplying roller arranged in contact with the developing roller and configured to supply toner to the developing roller. The developing roller and the toner-supplying roller are configured to be rotated under specific conditions. The electrophotographic photosensitive member includes a surface layer that is a polymerized film of a composition containing at least one kind of (meth)acrylic compound. The surface layer contains a metal oxide particle.

### BACKGROUND

### Field

The present disclosure relates to a process cartridge and an electrophotographic apparatus each including an electrophotographic photosensitive member.

### Description of the Related Art

In recent years, the extension of the service life of an electrophotographic apparatus has been strengthened. However, in an electrophotographic process, the extension of the service life is liable to cause various adverse effects. Thus, various efforts have been made to counter various adverse effects associated with the extension of the service life.

As one of the above-mentioned adverse effects, there is given a problem in that the amount of toner supplied from a developing roller to be mounted on the electrophotographic apparatus to an electrophotographic photosensitive member (hereinafter sometimes simply referred to as “photosensitive member”) is reduced through the repeated use of the apparatus, and hence the density of a printed image is decreased.

On one hand, the amount of the toner that has coated the top of the developing roller becomes insufficient (hereinafter also referred to as “coat amount insufficiency”), and the supply of the toner to the photosensitive member when a solid image is printed becomes insufficient. Accordingly, a phenomenon in which the density of the solid image reduces (hereinafter also referred to as “solid density reduction”) may occur.

On the other hand, the triboelectric charge quantity of the toner that has coated the top of the developing roller becomes excessive (hereinafter also referred to as “charge-up”), and the supply of the toner to the photosensitive member when a halftone image is printed becomes insufficient. Thus, a phenomenon in which the density of the halftone image reduces (hereinafter also referred to as “HT density reduction”) may occur.

To solve those disadvantages, the configuration of the developing roller and a toner-supplying roller that supplies the toner to the developing roller, and the configuration of the toner have been devised.

In Japanese Patent Application Laid-Open No. 2011-59167, there is a description of a configuration in which the rotation direction of the developing roller (developer-carrying member) and the rotation direction of the toner-supplying roller (toner-recovering and supplying member) are opposite to each other in a portion at which the respective members are rubbed against each other (hereinafter referred to as “counter configuration”). Background fogging and a developing ghost are suppressed by setting the recovery ratio of residual toner on the developing roller by the toner-supplying roller and the value of a charging amount per mass of toner to appropriate ranges under the above-mentioned counter configuration.

In Japanese Patent Application Laid-Open No. 2009-271418, there is a description of a configuration in which a ratio V_{RS}/V_{D} (hereinafter also referred to as “R”) of a peripheral velocity V_{RS} of the toner-supplying roller to a peripheral velocity V_{D} of the developing roller is 0.8 to 1.5. On one hand, the R is set to 0.8 or more under the counter configuration to ensure a coat amount on the developing roller, to thereby suppress the occurrence of a developing ghost. In addition, on the other hand, the R is set to 1.5 or less to alleviate a stress on the toner, to thereby suppress toner deterioration in the case of using toner having a small particle diameter.

In Japanese Patent Application Laid-Open No. 2016-184122, there is a description of particles each containing a metal oxide having a metal atom having a valence of 2 or more as an external additive of the toner. When the metal oxide is utilized as a charge control agent, the charge-up of the toner is suppressed, and hence a reduction in image density after the repeated formation of images on 5,000 sheets is suppressed.

According to investigations made by the inventors of the present disclosure, in each of the technologies as described in Japanese Patent Application Laid-Open No. 2011-59167, Japanese Patent Application Laid-Open No. 2009-271418, and Japanese Patent Application Laid-Open No. 2016-184122, the solid density reduction may occur at the time of the repeated use under a high-temperature and high-humidity environment, and the HT density reduction may occur at the time of the repeated use under a low-temperature and low-humidity environment.

### SUMMARY

Thus, an aspect of the present disclosure is to provide a process cartridge capable of suppressing each of: a solid density reduction at the time of the repeated use under a high-temperature and high-humidity environment; and a HT density reduction at the time of the repeated use under a low-temperature and low-humidity environment.

The above-mentioned aspect is achieved by the disclosure to be described below. That is, according to one aspect of the present disclosure, there is provided a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and the developing roller and the toner-supplying roller are rotated while R represented by the following formula (E1) satisfies 1.2≤R≤1.5:

$$R = {V}_{RS} / {V}_{D} \qquad ( E1 )$$

in the formula (E1), V_{RS} represents an absolute value of a peripheral velocity [m/s] of the toner-suppling roller, and V_{D} represents an absolute value of a peripheral velocity [m/s] of the developing roller, wherein the electrophotographic photosensitive member includes a surface layer that is a polymerized film of a composition containing at least one kind of (meth)acrylic compound selected from the group consisting of: a (meth)acrylic monomer; and a (meth)acrylic oligomer, and wherein the surface layer contains a metal oxide particle.

According to the present disclosure, there can be provided the process cartridge capable of suppressing each of: the solid density reduction at the time of the repeated use under a high-temperature and high-humidity environment; and the HT density reduction at the time of the repeated use under a low-temperature and low-humidity environment.

Further features of the present disclosure will become apparent from the following description of exemplary embodiments with reference to the attached drawings.

### BRIEF DESCRIPTION OF THE DRAWINGS

FIG. 1 is a schematic sectional view of a process cartridge according to one embodiment of the present disclosure.

FIG. 2 is a schematic view for illustrating the drive mechanism of a toner-supplying roller and a developing roller according to one embodiment of the present disclosure.

FIG. 3 is a schematic view for illustrating the drive mechanism of a toner-supplying roller and a developing roller according to one embodiment of the present disclosure.

### DESCRIPTION OF THE EMBODIMENTS

The present disclosure is described in detail below by way of exemplary embodiments.

The present disclosure relates to a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and the developing roller and the toner-supplying roller are rotated while R represented by the following formula (E1) satisfies 1.2≤R≤1.5:

$$R = {V}_{RS} / {V}_{D} \qquad ( E1 )$$

in the formula (E1), V_{RS} represents an absolute value of a peripheral velocity [m/s] of the toner-suppling roller, and V_{D} represents an absolute value of a peripheral velocity [m/s] of the developing roller, wherein the electrophotographic photosensitive member includes a surface layer that is a polymerized film of a composition containing at least one kind of (meth)acrylic compound selected from the group consisting of: a (meth)acrylic monomer; and a (meth)acrylic oligomer, and wherein the surface layer contains a metal oxide particle. The term “(meth)acrylic” as used herein means “acrylic or methacrylic.” That is, the (meth)acrylic monomer refers to an acrylic monomer or a methacrylic monomer, and the (meth)acrylic oligomer refers to an acrylic oligomer or a methacrylic oligomer. In addition, the (meth)acrylic compound refers to an acrylic compound or a methacrylic compound.

In recent years, the further extension of the service life of the electrophotographic apparatus has been required, and the number of repetitions of use thereof has increased even more. In contrast, as a result of the investigations made by the inventors of the present disclosure, in the related art, the suppression of both of a solid density reduction due to significant coat amount insufficiency caused by the repeated use under a high-temperature and high-humidity environment, and a HT density reduction due to significant charge-up caused by the repeated use under a low-temperature and low-humidity environment may be insufficient. In particular, in a configuration in which a charge control agent is added as an external additive of the toner, the amount of the charge control agent does not change, though there is a significant difference between the degrees of the charge-up in the initial stage of the repeated use under the low-temperature and low-humidity environment, and after the repeated use. Thus, both of the triboelectric charge quantity of the toner in the initial stage and the triboelectric charge quantity thereof after the repeated use cannot be optimized by controlling the addition amount of the charge control agent.

In view of the foregoing, the inventors of the present disclosure have investigated the combination of the configuration according to the combination of the developing roller and the toner-supplying roller, and a material for forming the surface of the photosensitive member. As a result, the inventors have found that the above-mentioned problem can be solved by designing each of the configuration of the developing roller and the toner-supplying roller, and the photosensitive member surface material as described below, and combining the designs with each other.

### <Configuration According to Combination of Developing Roller and Toner-Supplying Roller>

In the present disclosure, the developing roller and the toner-supplying roller are rotated while the R represented by the following formula (E1) satisfies 1.2≤R≤1.5. In addition, the toner-supplying roller and the developing roller are configured so that the movement direction of the surface of the developing roller is opposite to the movement direction of the surface of the toner-supplying roller at a contact position with the toner-supplying roller.

$$R = {V}_{RS} / {V}_{D} \qquad ( E1 )$$

in the formula (E1), V_{RS} represents an absolute value of a peripheral velocity [m/s] of the toner-suppling roller, and V_{D} represents an absolute value of a peripheral velocity [m/s] of the developing roller.

On one hand, because of the configuration in which the R satisfies 1.2≤R≤1.5, a satisfactory amount of the toner can be stably supplied from the toner-supplying roller to the developing roller. As a result, the occurrence of the coat amount insufficiency on the developing roller is suppressed, and hence the solid density reduction in the repeated use under the high-temperature and high-humidity environment can be satisfactorily suppressed.

On the other hand, because of the counter configuration of the toner-supplying roller with respect to the developing roller, the toner remaining on the developing roller after development from the developing roller to the photosensitive member is performed is forcefully scraped off by the toner-supplying roller. As a result, an increase in triboelectric charge quantity of the toner per one rotation of the developing roller caused by the continuous remaining of the toner that coats the top of the developing roller in each development process can be suppressed.

### <Material for Forming Surface of Photosensitive Member>

The photosensitive member to be used in the present disclosure includes a surface layer that is a polymerized film of a composition containing at least one kind of (meth)acrylic compound selected from the group consisting of: a (meth)acrylic monomer; and a (meth)acrylic oligomer. In addition, the surface layer contains a metal oxide particle.

The effect of incorporating a surface layer that is a polymerized film of a composition containing at least one kind of (meth)acrylic compound selected from the group consisting of: a (meth)acrylic monomer; and a (meth)acrylic oligomer in the electrophotographic photosensitive member to be used in the present disclosure is described below. In addition, the effect of incorporating the metal oxide particle into the surface layer is described.

As described in the section <Configuration according to Combination of Developing Roller and Toner-supplying Roller>, when the configuration according to the combination of the developing roller and the toner-supplying roller is devised, the solid density reduction in the repeated use under the high-temperature and high-humidity environment can be suppressed. In addition, an increase in triboelectric charge quantity of the toner per one rotation of the developing roller caused by the continuous remaining of the toner can be suppressed. However, when the developing roller and the toner-supplying roller are set to have a counter configuration, and the R is set to a value larger than 1, the rubbing between the developing roller and the toner-supplying roller at a contact portion therebetween increases. Thus, the charge-up of the toner is liable to occur in the repeated use under the low-temperature and low-humidity environment, and the charge-up has caused a HT density reduction. In contrast, in the present disclosure, an electrophotographic photosensitive member including a surface layer that is a polymerized film of a specific composition, in which the surface layer contains a metal oxide particle, is used. Herein, the specific composition refers to a composition containing at least one kind of (meth)acrylic compound selected from the group consisting of: a (meth)acrylic monomer; and a (meth)acrylic oligomer. Thus, the occurrence of a HT density reduction in the repeated use under the low-temperature and low-humidity environment is suppressed.

The inventors of the present disclosure have presumed the mechanism via which the HT density reduction in the repeated use under the low-temperature and low-humidity environment is suppressed by using the electrophotographic photosensitive member having the characteristics as described above to be described below.

In general, the charge control agent is used as an external additive of the toner in order to suppress the charge-up of the toner. However, as already described above, the amount of the charge control agent does not change, though there is a significant difference between the degrees of the charge-up in the initial stage of the repeated use under the low-temperature and low-humidity environment, and after the repeated use. Thus, both of the triboelectric charge quantity of the toner in the initial stage and the triboelectric charge quantity thereof after the repeated use cannot be optimized. The determination of the selection of the kind or amount of the charge control agent needs to be made in consideration that the triboelectric charge quantity in the initial stage does not become too small, and hence a satisfactory suppressing effect on the charge-up after the repeated use under the low-temperature and low-humidity environment may not be obtained.

In addition, the charge control agent exhibits a suppressing effect on the HT density reduction by reducing the triboelectric charge quantity on the developing roller, but also has a reducing effect on the triboelectric charge quantity even when present on the toner-supplying roller. Thus, the supply amount of the toner from the toner-supplying roller to the developing roller may reduce to promote the solid density reduction due to coat amount insufficiency as described above.

In view of the foregoing, in the present disclosure, the configuration in which unlike the related-art, the charge control agent is released from the surface layer of the photosensitive member as the photosensitive member surface is scraped is achieved by using the metal oxide incorporated into the surface layer of the photosensitive member as the charge control agent. Thus, a state in which the amount of the charge control agent is small in the initial stage, and the amount of the charge control agent on the developing roller increases as the number of repetitions of use under the low-temperature and low-humidity environment increases can be achieved. Thus, optimal control of the triboelectric charge quantity of the toner from the initial stage to any time point after the repeated use is enabled.

In addition, the metal oxide to be incorporated into the surface layer of the photosensitive member is preferentially transferred to the developing roller arranged on a position close to the photosensitive member as the surface layer is scraped. Thus, the following adverse effects can also be avoided: the reduction in triboelectric charge quantity resulting from the presence of the charge control agent on the toner-supplying roller to be arranged at a position relatively far from the photosensitive member; and the promotion of the solid density reduction caused by the coat amount insufficiency due to the reduction in triboelectric charge quantity.

Further, in the present disclosure, a polymerized film of a composition containing at least one kind of (meth)acrylic compound selected from the group consisting of: a (meth)acrylic monomer; and a (meth)acrylic oligomer is used as the surface layer of the photosensitive member. Thus, while a photosensitive member having a long life and withstanding repeated use is supplied, the scraped amount of the surface layer per one rotation of the developing roller is appropriately adjusted so that the supply amount of the metal oxide serving as the charge control agent to the developing roller does not become excessive.

Two amounts, that is, the toner coat amount on the developing roller and the triboelectric charge quantity of the toner are interrelated with each other in the toner-supplying roller, the developing roller, and the contact portion between both the rollers. Thus, even when an attempt is made to suppress the solid density reduction by simply increasing the triboelectric charge quantity of the toner itself to increase the coat amount as described above, in the case where the triboelectric charge quantity is excessive, the developing amount of the toner from the developing roller to a drum reduces at the time of the formation of a HT image. Then, the HT density reduction thus occurs (reference: Masahiro Hosoya and Mitsunaga Saito, Contact-type Monocomponent Nonmagnetic Development System (I)—Theory and Optimization-, Denshi Shashin Gakkaishi (Electrophotography), Vol. 31, No. 4, 1992). In the present disclosure, the relationship between the two amounts, that is, the toner coat amount on the developing roller and the triboelectric charge quantity of the toner can be optimized from the initial stage to any time point after the repeated use by the combination of the section <Configuration according to Combination of Developing Roller and Toner-supplying Roller> and the section <Material for forming Surface of Photosensitive Member>. Then, both of the solid density reduction in the repeated use under the high-temperature and high-humidity environment, and the HT density reduction in the repeated use under the low-temperature and low-humidity environment are thus suppressed.

As described in the above-mentioned mechanism, the above-mentioned configuration according to the combination of the developing roller and the toner-supplying roller, and the above-mentioned material for forming the surface of the photosensitive member exhibit synergistic effects on each other in the process cartridge according to the present disclosure. Then, the effects of the present disclosure can thus be obtained.

The configuration of the photosensitive member used in the present disclosure is described in detail below.

### [Electrophotographic Photosensitive Member]

The photosensitive member to be used in the present disclosure includes a surface layer.

A method of producing the photosensitive member used in the present disclosure is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

A support and the respective layers are described below.

### <Support>

In the present disclosure, the photosensitive member includes the support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

In the photosensitive member used in the present disclosure, an electroconductive layer may be arranged on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof. Examples of the doping element and the oxide thereof include phosphorus, aluminum, niobium, and tantalum.

In addition, the electroconductive particles may each have a laminated configuration including a core particle and a covering layer covering the core particle. A material for the core particle is, for example, titanium oxide, barium sulfate, or zinc oxide. A material for the covering layer is, for example, a metal oxide such as tin oxide or titanium oxide.

In addition, when the metal oxide is used as the electroconductive particles, the volume-average particle diameter of the particles is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The thickness of the electroconductive layer is preferably 1 to 50 μm, particularly preferably 3 to 40 μm.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

In the photosensitive member used in the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting substance, a metal oxide, a metal, an electroconductive polymer, and the like for the purpose of improving electric characteristics. Of those, an electron transporting substance and a metal oxide are preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably 0.1 to 50 μm, more preferably 0.2 to 40 μm, particularly preferably 0.3 to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the photosensitive member according to the present disclosure is mainly classified into (1) a laminate type photosensitive layer and (2) a monolayer type photosensitive layer. (1) The laminate type photosensitive layer includes a charge generating layer containing a charge generating substance and a charge transporting layer containing a charge transporting substance. (2) The monolayer type photosensitive layer includes a photosensitive layer containing both of the charge generating substance and the charge transporting substance.

### (1) Laminate Type Photosensitive Layer

The laminate type photosensitive layer includes the charge generating layer and the charge transporting layer.

### (1-1) Charge Generating Layer

The charge generating layer preferably contains the charge generating substance and a resin.

Examples of the charge generating substance include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge generating substance in the charge generating layer is preferably 40 to 85 mass %, more preferably 60 to 80 mass % with respect to the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The thickness of the charge generating layer is preferably 0.1 to 1 μm, more preferably 0.15 to 0.4 μm.

The charge generating layer may be formed by: preparing a coating liquid for a charge generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge Transporting Layer

The charge transporting layer preferably contains the charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Structures of CTM1 to CTM10 as the examples of the preferable charge transporting substance are shown below.

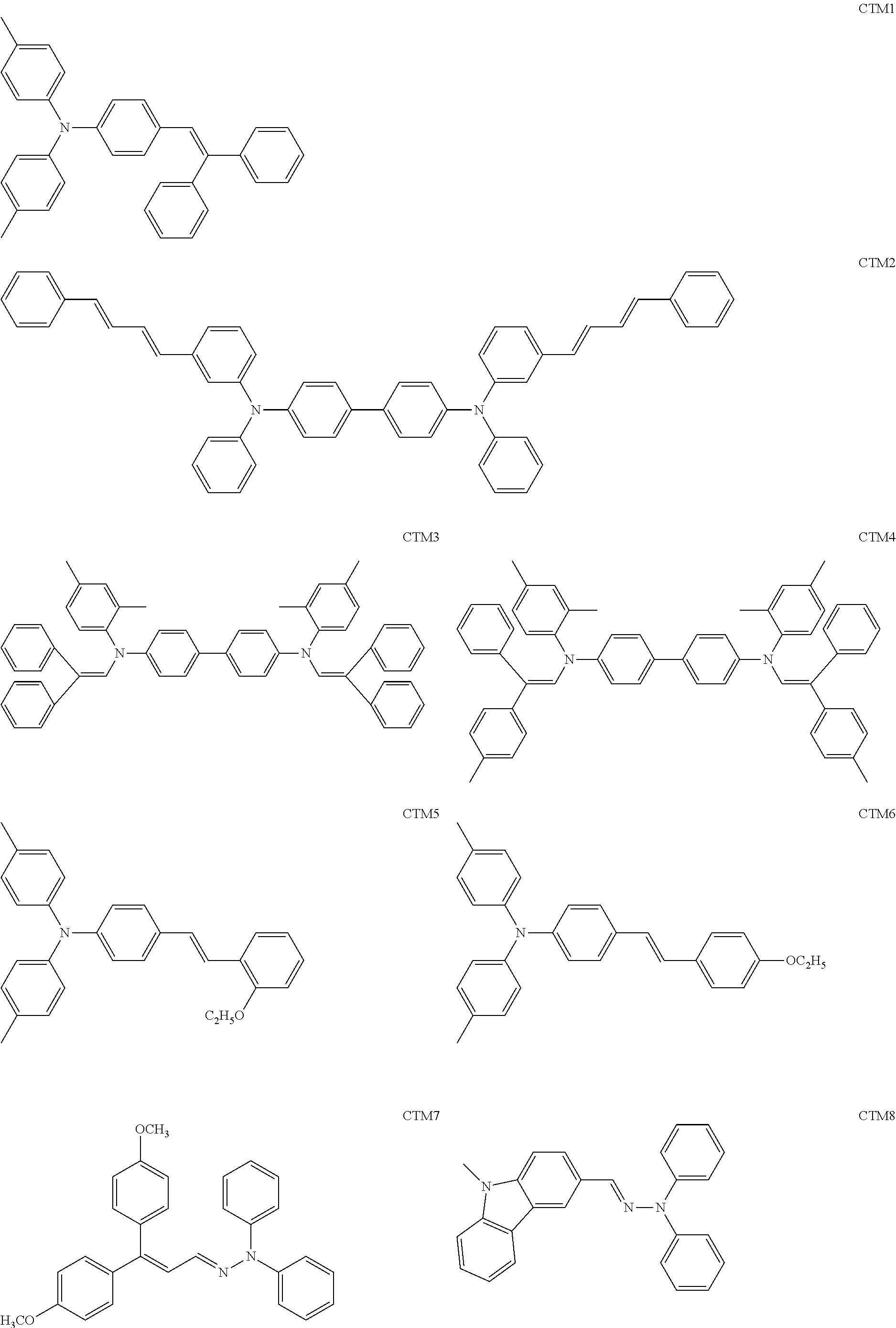

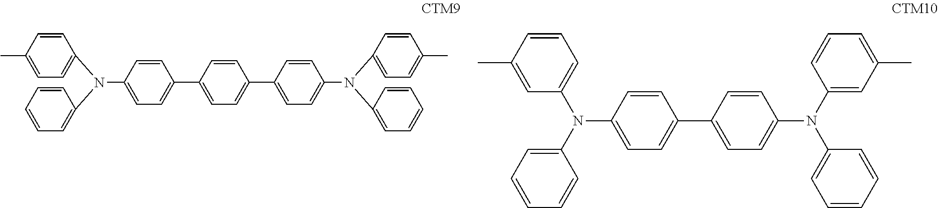

The content of the charge transporting substance in the charge transporting layer is preferably 25 to 70 mass %, more preferably 30 to 55 mass % with respect to the total mass of the charge transporting layer.

Examples of the resin include a polyester resin, a polycarbonate resin, an acrylic resin, and a polystyrene resin. Of those, a polycarbonate resin, a polyester resin, and an acrylic resin are preferred. A polyarylate resin is particularly preferred as the polyester resin.

A content ratio (mass ratio) between the charge transporting substance and the resin is preferably 4:10 to 20:10, more preferably 5:10 to 12:10.

In addition, the charge transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The thickness of the charge transporting layer is preferably 5 to 50 μm, more preferably 8 to 40 μm, particularly preferably 10 to 30 μm.

The charge transporting layer may be formed by: preparing a coating liquid for a charge transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge generating substance, the charge transporting substance, a resin, and a solvent; forming a coating film of the coating liquid; and drying the coating film. The charge generating substance, the charge transporting substance, and the resin are the same as the examples of the materials in the above-mentioned section “(1) Laminate Type Photosensitive Layer.”

### <Protection Layer>

In the photosensitive member according to the present disclosure, a protection layer may be arranged on the photosensitive layer. The arrangement of the protection layer can improve durability.

It is only required that the protection layer be, for example, a resin-containing layer having high strength from the viewpoint that the layer is arranged for the purpose of imparting durability in response to a long life. It is not necessarily required to enhance the charge transporting performance of the layer by incorporating electroconductive particles or a charge transporting substance into the layer. However, from the viewpoint of enhancing the basic electrical characteristics of the photosensitive member, it is preferred to achieve both the durability and the basic electrical characteristics by incorporating the electroconductive particle and/or the charge transporting substance, and a resin.

Examples of the electroconductive particles include particles of metal oxides, such as titanium oxide, zinc oxide, tin oxide, and indium oxide.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protection layer may be formed as a cured film by polymerizing a composition containing a monomer having a polymerizable functional group. As a reaction in this case, there are given, for example, a thermal polymerization reaction, a photopolymerization reaction, and a radiation polymerization reaction. Examples of the polymerizable functional group of the monomer having a polymerizable functional group include an acryloyl group and a methacryloyl group. A material having a charge transporting ability may be used as the monomer having a polymerizable functional group.

The protection layer may contain an additive, such as an antioxidant, a UV absorber, a plasticizer, a leveling agent, a slipperiness-imparting agent, or a wear resistance-improving agent. Specific examples of the additive include a hindered phenol compound, a hindered amine compound, a sulfur compound, a phosphorus compound, a benzophenone compound, a siloxane-modified resin, a silicone oil, a fluorine resin particle, a polystyrene resin particle, a polyethylene resin particle, a silica particle, an alumina particle, and a boron nitride particle.

The protection layer has a thickness of preferably 0.5 to 10 μm, more preferably 1 to 7 μm.

The protection layer may be formed by: preparing a coating liquid for a protection layer containing the above-mentioned materials and a solvent; forming a coat thereof, and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

### <Surface Layer>

In the photosensitive member to be used in the present disclosure, the surface layer is a polymerized film of a composition containing at least one kind of (meth)acrylic compound selected from the group consisting of: a (meth)acrylic monomer; and a (meth)acrylic oligomer, and the surface layer contains a metal oxide particle.

The surface layer as used herein is a portion in which the photosensitive member is brought into contact with toner and various members during an electrophotographic process. The protection layer, the charge transporting layer, and the monolayer type photosensitive layer may each be the surface layer, but the surface layer is preferably the protection layer from the viewpoint of achieving both a long life and durability in the repeated use, and the basic electrical characteristics in the electrophotographic process.

The metal oxide particle preferably has a low volume resistivity and easily exhibits the effect as the charge control agent to the toner. From this viewpoint, the metal oxide particle preferably include at least any one kind of metal oxide particle selected from the group consisting of: an indium tin oxide particle, a tin oxide particle, a titanium oxide particle, a zinc oxide particle, and an aluminum oxide particle.

“n” kinds (where “n” represents an integer of 1 or more) of the metal oxide particle are each represented by a metal oxide particle Aᵢ (where “i” represents an integer of 1 to “n”). In addition, the volume resistivity of the metal oxide particle Aᵢ is represented by ρᵢ [Ω·cm]. In addition, the volume content of the metal oxide particle Aᵢ in the surface layer with respect to the entirety of the surface layer is represented by Rᵢ [%]. In this case, it is preferred that, in the process cartridge according to the present disclosure, the total sum from i=1 to i=n of (Rᵢ/ρᵢ) satisfy the following formula (E2).

$${10}^{- 1} < {\sum }_{i = 1}^{n} {R}_{i} / {ρ}_{i} < {10}^{1} \qquad ( E2 )$$

When the total sum from i=1 to i=n of (Rᵢ/ρᵢ) is more than 10⁻¹⁰, a charge control function to the toner is high, and hence the charge-up can be more effectively suppressed. In addition, when the total sum from i=1 to i=n of (Rᵢ/ρᵢ) is less than 10¹, the triboelectric charge quantity of the toner on the toner-supplying roller is free from being reduced to an extent more than necessary, and hence the occurrence of the solid density reduction caused by the coat amount insufficiency can be suppressed.

Further, in the process cartridge according to the present disclosure, it is more preferred to satisfy the following formula (E3).

$${10}^{- 2} < {\sum }_{i = 1}^{n} {R}_{i} / {ρ}_{i} < {10}^{1} \qquad ( E3 )$$

When the total sum from i=1 to i=n of (Rᵢ/ρᵢ) is more than 10⁻², the charge-up can be more effectively suppressed. Thus, the balance of the charge control performance in order to optimize the toner coat amounts and the toner triboelectric charge quantities on the toner-supplying roller and the developing roller from the initial stage to any time point after the repeated use can be further improved.

The metal oxide particle preferably includes a metal oxide particle having a volume resistivity of 10³ [Ω·cm] or less from the viewpoint of the balance of the charge performance. Specifically, the metal oxide particle preferably include an indium tin oxide particle.

It is preferred that the (meth)acrylic compound provide a long life and durability in the repeated use, and can appropriately control the release amount of the metal oxide particle per one rotation of the developing roller. From this viewpoint, the (meth)acrylic compound preferably contains at least one kind of (meth)acrylic compound that is trifunctional or more selected from the group consisting of: a (meth)acrylic monomer that is trifunctional or more; and a (meth)acrylic oligomer that is trifunctional or more. In addition, the (meth)acrylic compound more preferably contains at least one kind of (meth)acrylic compound that is hexafunctional selected from the group consisting of: a (meth)acrylic monomer that is hexafunctional; and a (meth)acrylic oligomer that is hexafunctional.

The surface layer of the photosensitive member to be used in the present disclosure is preferably free of an organic compound having a charge transporting function from the viewpoint of cost.

The surface layer of the photosensitive member to be used in the present disclosure contains the metal oxide particle, which are responsible for the charge transporting function to some degree, but the thickness of the surface layer is preferably 0.5 to 10 μm when the surface layer is free of an organic compound having a charge transporting function. On one hand, when the thickness of the surface layer is less than 0.5 μm, there is a higher risk in that a portion free from being covered with the surface layer is present, and hence the surface layer may not be able to exhibit the function. On the other hand, when the thickness of the surface layer is more than 10 μm, at the time of the charging of the electrophotographic photosensitive member during an electrophotographic process, the surface layer retains a large shared voltage because no organic compound having a charge transporting function is present. As a result, a residual potential may become extremely large to cause deterioration of the basic electrical characteristics.

When the surface layer contains a charge transporting substance, the thickness of the surface layer is preferably 0.5 to 20 μm, more preferably 1 to 14 μm.

The surface layer may be formed by: preparing a coating liquid for a surface layer containing the above-mentioned (meth)acrylic compound, the above-mentioned metal oxide particle, the respective materials described in the above-mentioned section <Photosensitive Layer> and/or the above-mentioned section <Protection Layer>, and a solvent; forming a coating film of the coating liquid; and drying and/or curing the coating film. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

The surface layer is formed as a cured film by subjecting the composition containing a (meth)acrylic compound to a polymerization reaction. A reaction in this case is, for example, a thermal polymerization reaction, a photopolymerization reaction, or a radiation polymerization reaction.

The structures of ACM1 to ACM54 are shown below as preferred examples of the (meth)acrylic monomer.

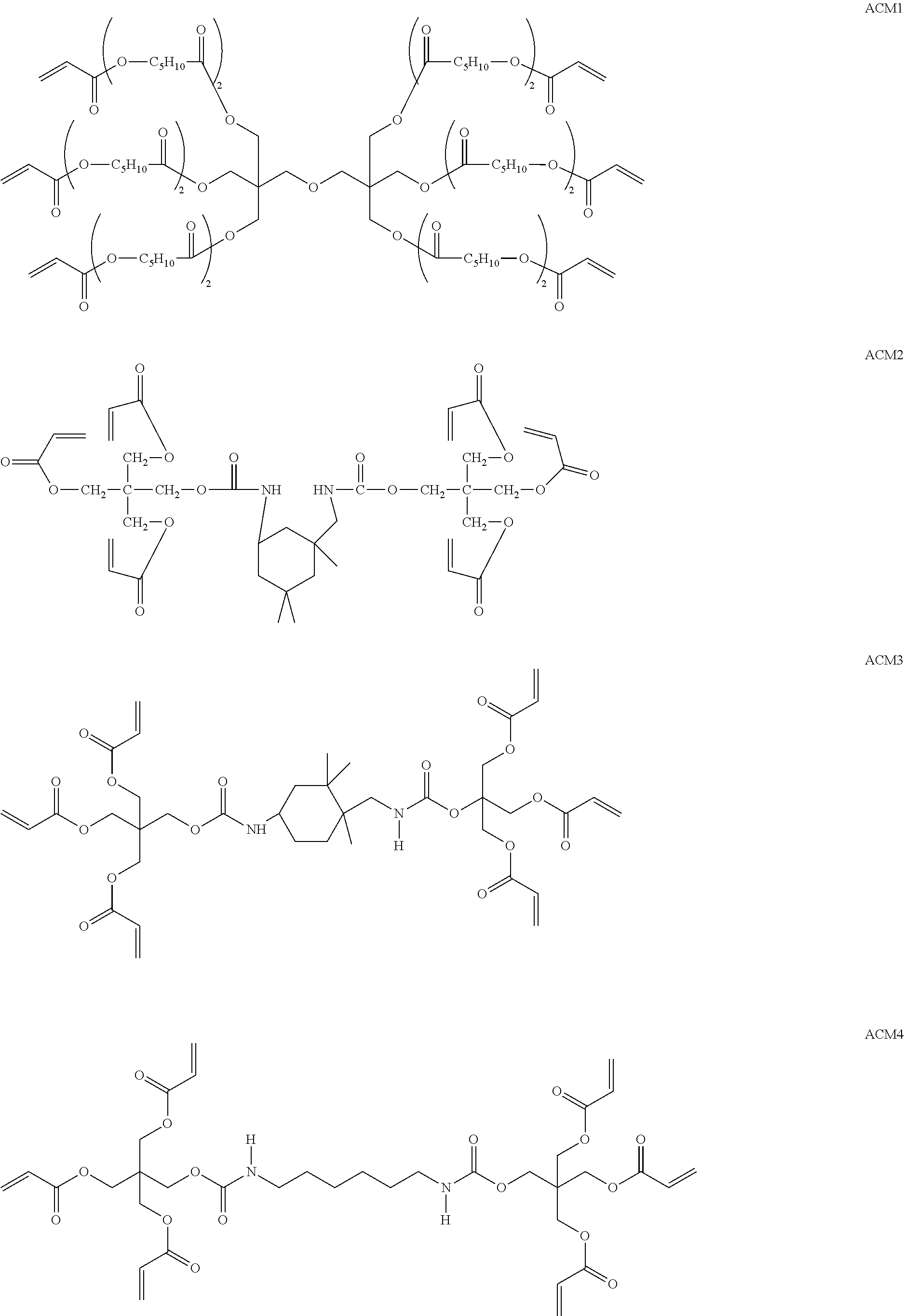

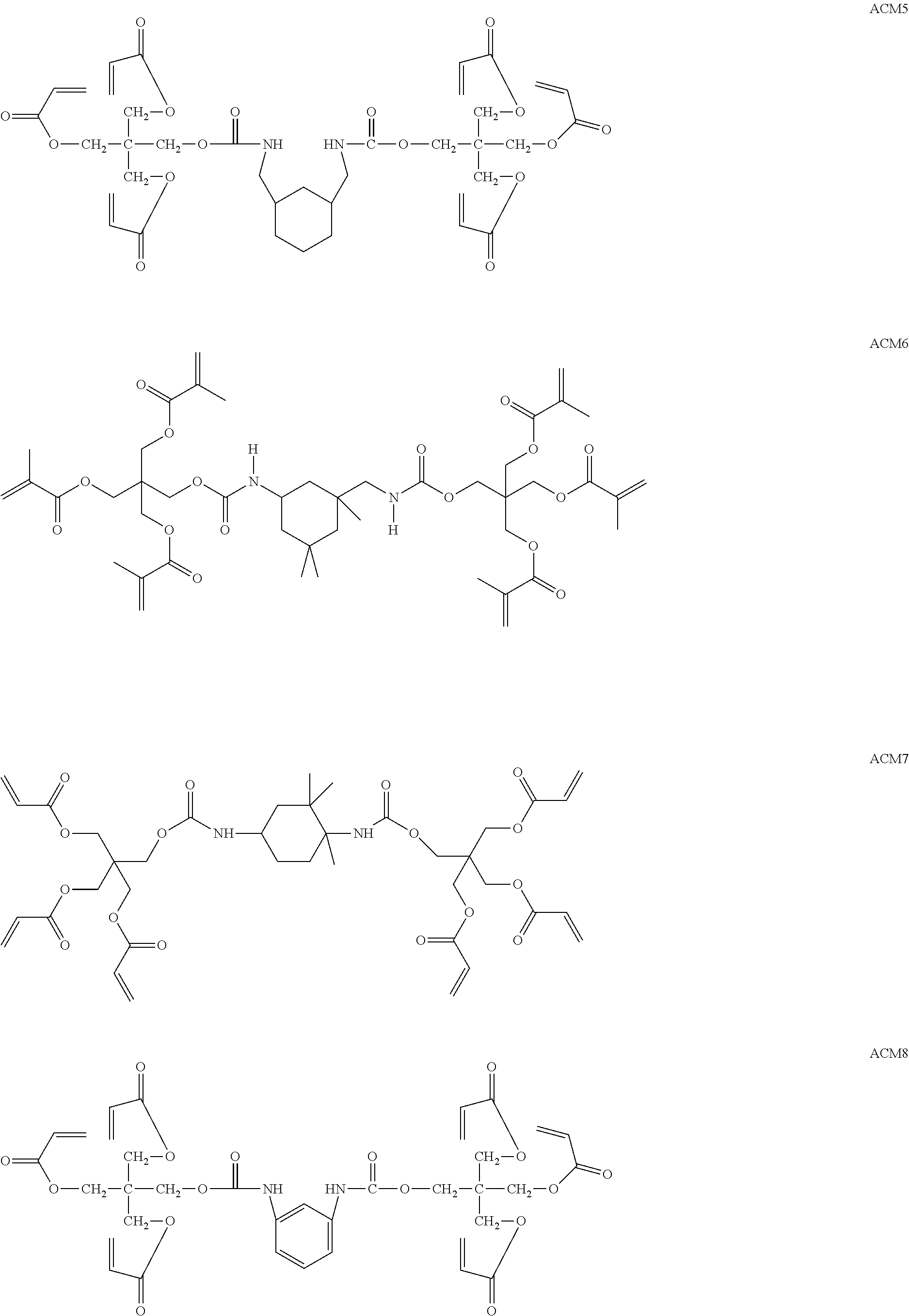

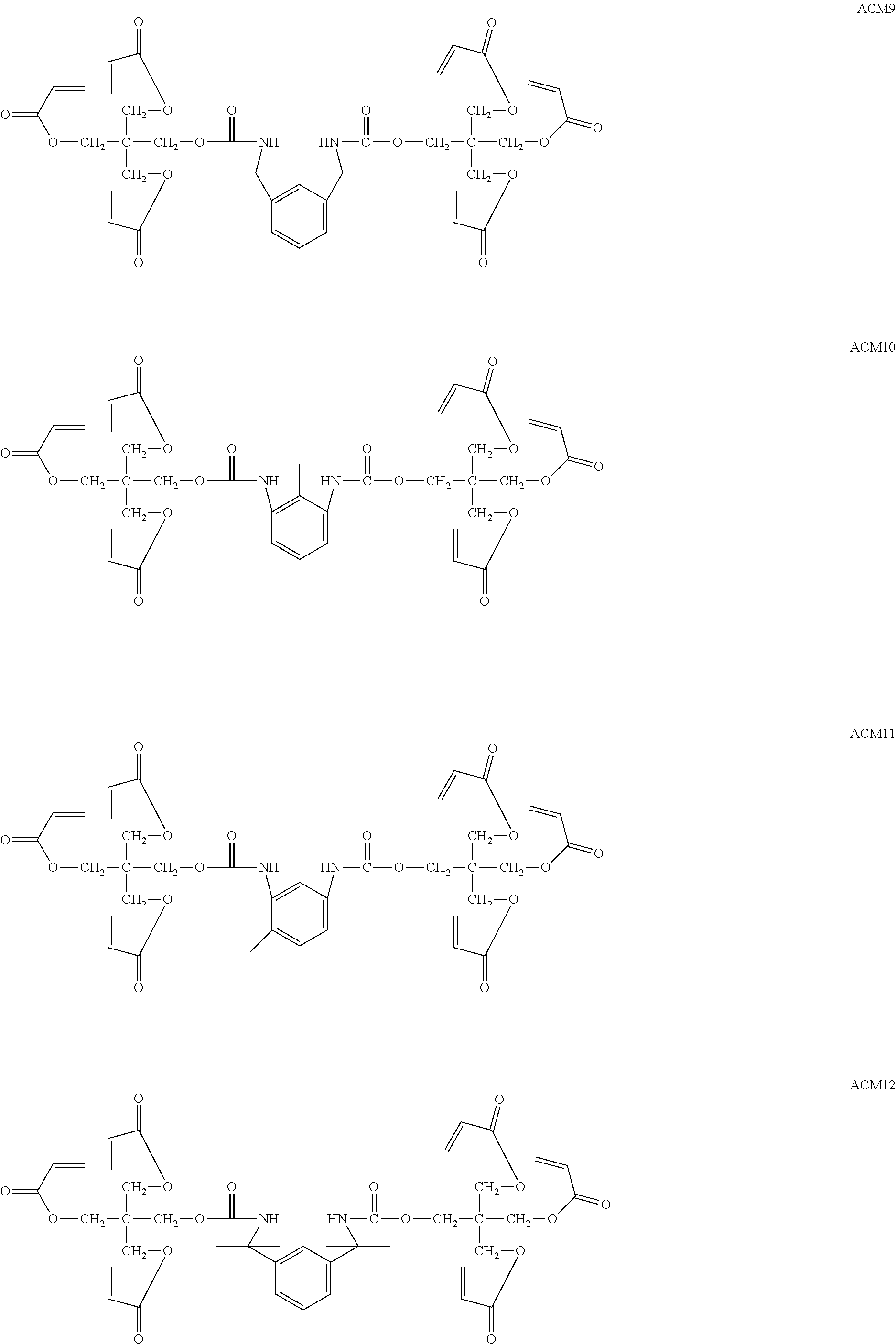 [SMILES: C=CC(=O)OCC(COC(=O)C=C)(COC(=O)C=C)COC(=O)NCc1cccc(CNC(=O)OCC(COC(=O)C=C)(COC(=O)C=C)COC(=O)C=C)c1 ; C=CC(=O)OCC(COC(=O)C=C)(COC(=O)C=C)COC(=O)Nc1cccc(NC(=O)OCC(COC(=O)C=C)(COC(=O)C=C)COC(=O)C=C)c1C ; C=CC(=O)OCC(COC(=O)C=C)(COC(=O)C=C)COC(=O)Nc1ccc(C)c(NC(=O)OCC(COC(=O)C=C)(COC(=O)C=C)COC(=O)C=C)c1 ; C=CC(=O)OCC(COC(=O)C=C)(COC(=O)C=C)COC(=O)NC(C)(C)c1cccc(C(C)(C)NC(=O)OCC(COC(=O)C=C)(COC(=O)C=C)COC(=O)C=C)c1]

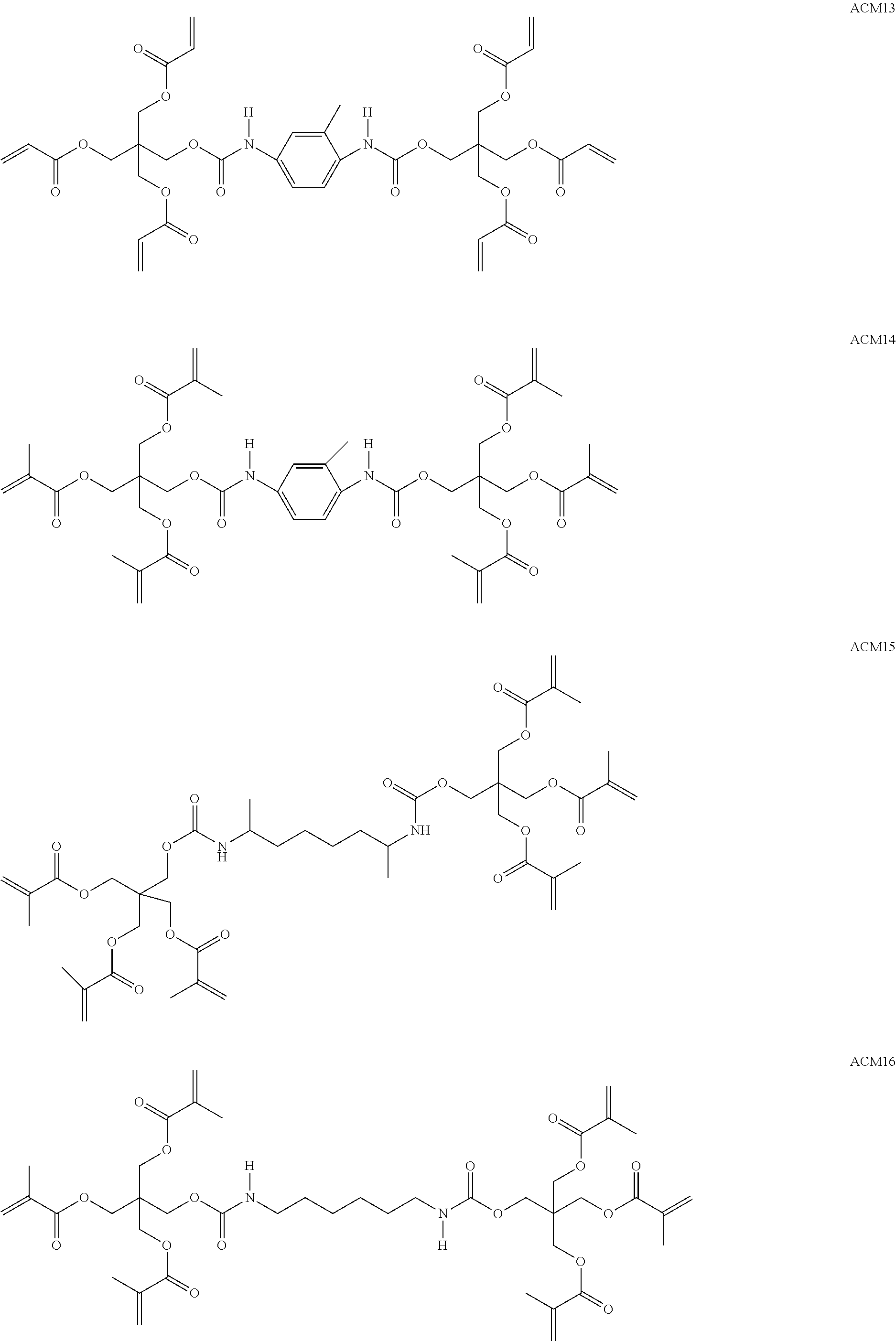

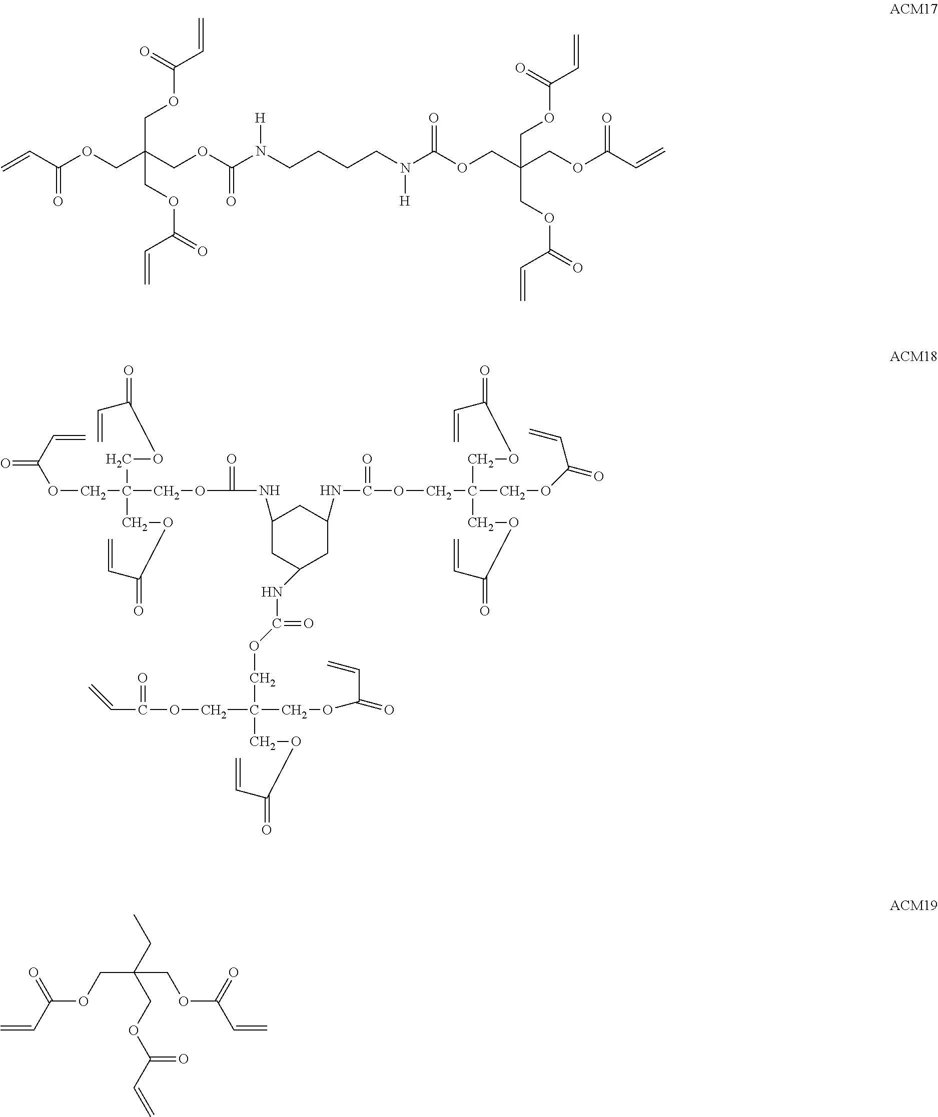

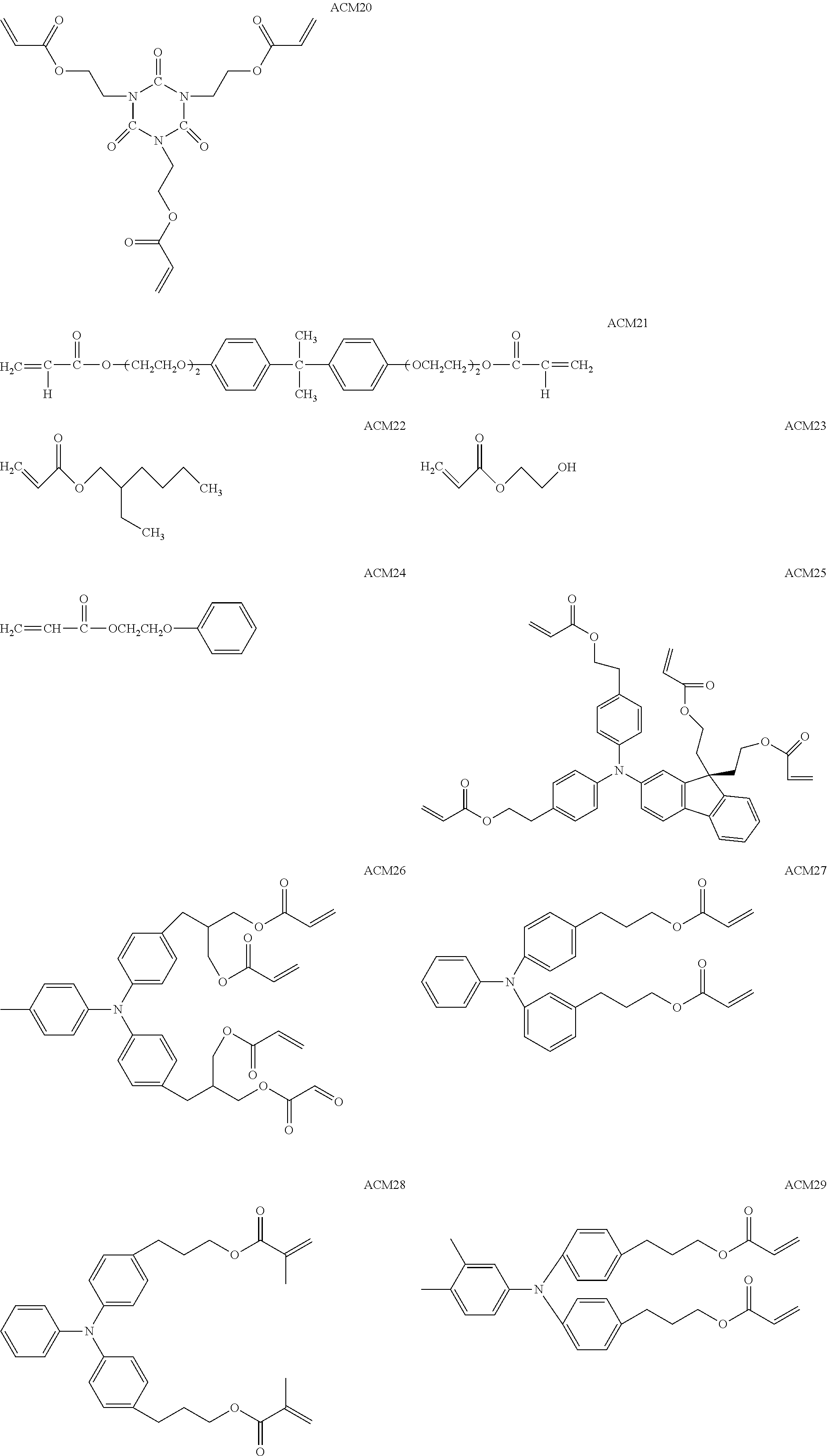

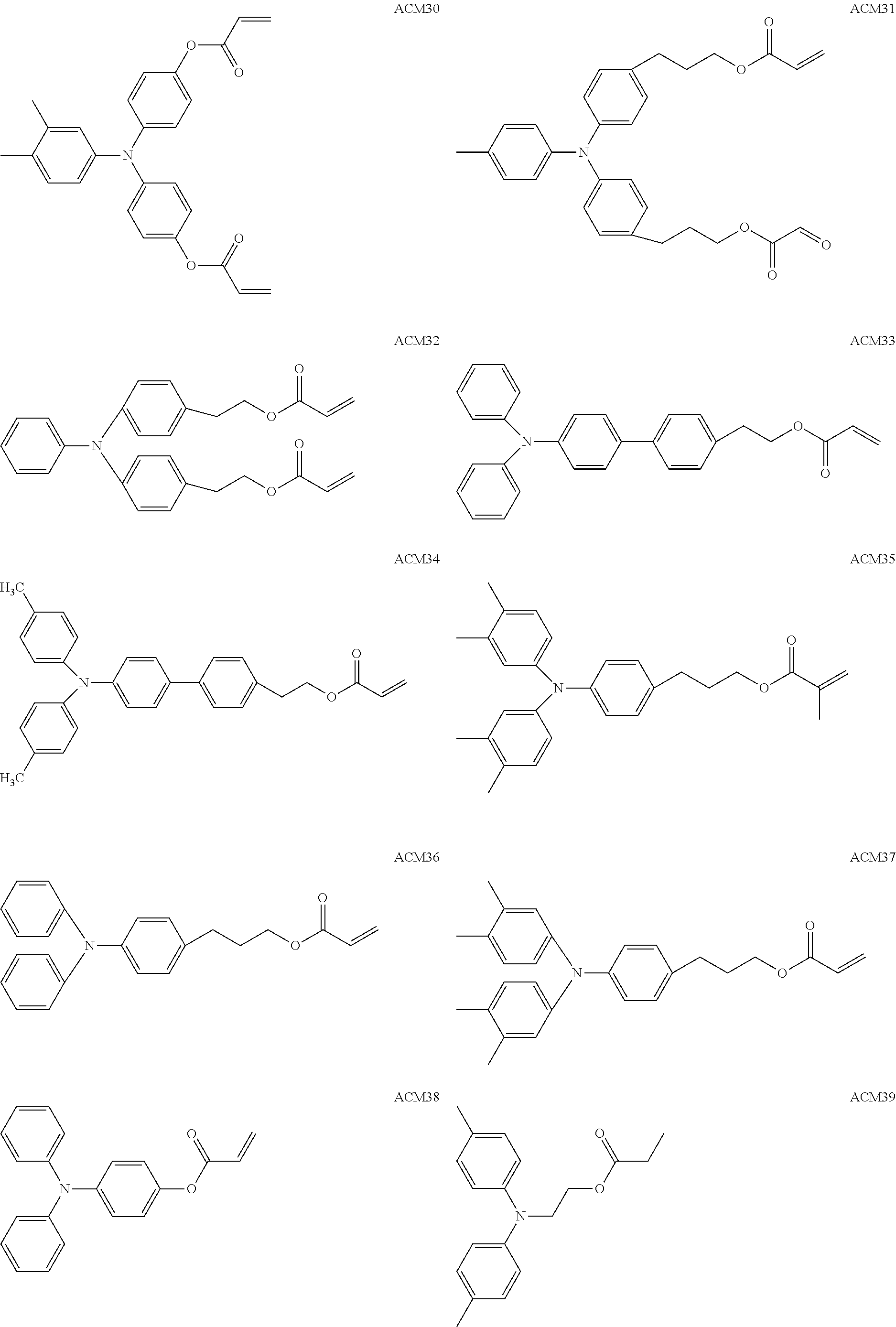

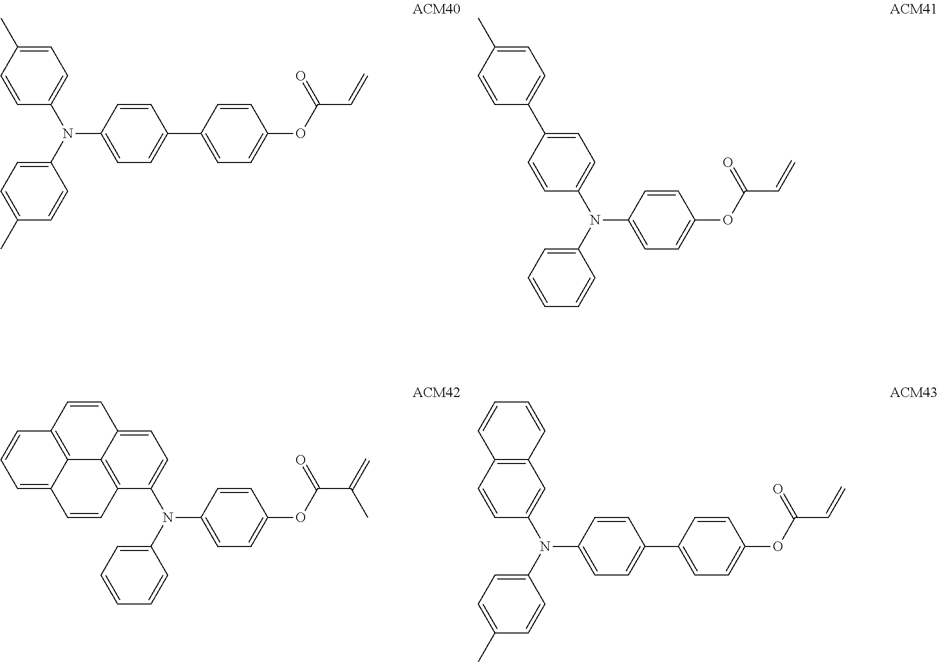 [SMILES: C=CC(=O)Oc1ccc(-c2ccc(N(c3ccc(C)cc3)c3ccc(C)cc3)cc2)cc1 ; C=CC(=O)Oc1ccc(N(c2ccccc2)c2ccc(-c3ccc(C)cc3)cc2)cc1 ; C=C(C)C(=O)Oc1ccc(N(c2ccccc2)c2ccc3ccc4cccc5ccc2c3c45)cc1 ; C=CC(=O)Oc1ccc(-c2ccc(N(c3ccc(C)cc3)c3ccc4ccccc4c3)cc2)cc1]

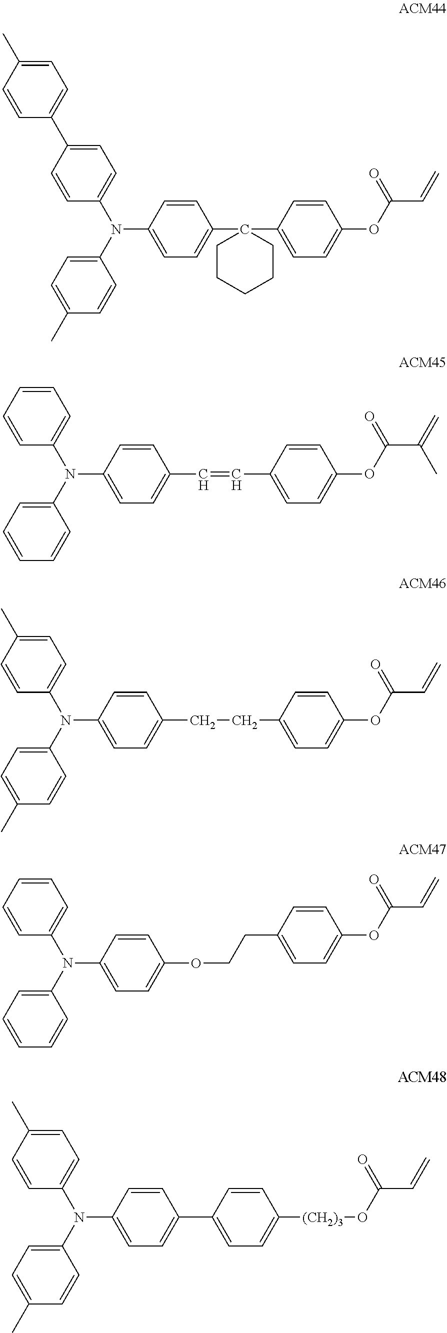

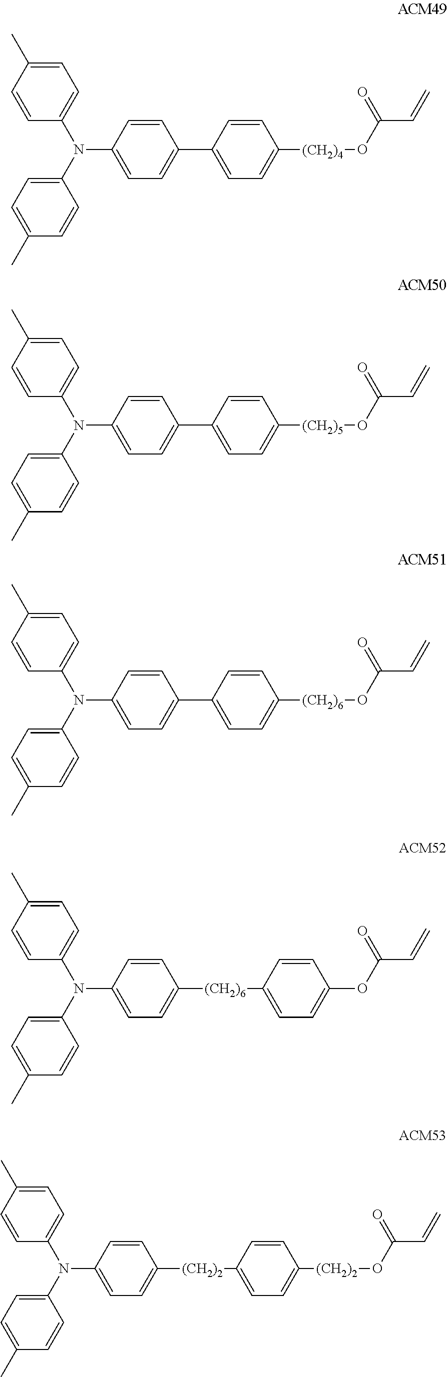

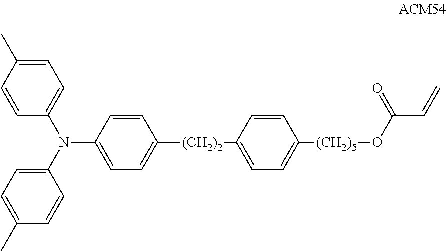

### <Identification Method for (Meth)Acrylic Compound>

The fact that the electrophotographic photosensitive member to be used in the present disclosure includes a surface layer formed by polymerizing the composition containing a (meth)acrylic compound may be identified as described below. In addition, the structural formulae of a plurality of kinds of (meth)acrylic monomers and/or (meth)acrylic oligomers, and the content ratios thereof may be identified as described below.

(1) The electrophotographic photosensitive member is immersed in chloroform. The surface layer formed by polymerizing (meth)acrylic compounds is insoluble in chloroform. Because of this, the surface layer is separated from the electrophotographic photosensitive member in chloroform, and a chloroform solution in which a layer below the surface layer has eluted is obtained.

(2) The solution is analyzed through use of chromatography, accurate mass spectrometry, nuclear magnetic resonance spectroscopy, pyrolysis-gas chromatography, or the like. Thus, a plurality of kinds of unreacted (meth)acrylic monomers and/or (meth)acrylic oligomers in the layer below the surface layer are identified.

(3) The identified plurality of kinds of (meth)acrylic monomers and/or (meth)acrylic oligomers are prepared in predetermined amounts by synthesis, purchase, or the like and subjected to homopolymerization.

(4) Each of the polymerized plurality of kinds of polymers is analyzed by infrared absorption spectroscopy, and a calibration peak is determined as a peak used for obtaining a calibration curve in an obtained infrared absorption spectrum. In this case, under the condition that no calibration peaks of other polymers can be found in a range of three times the half-width of the calibration peak, the calibration peak of each of the (meth)acrylic monomers is selected so as to maximize a peak intensity.

(5) For each polymer, a calibration range defined in a range of three times the half-width centered on the calibration peak is determined.

(6) Infrared absorption spectra when at least two kinds of unreacted (meth)acrylic monomers and/or (meth)acrylic oligomers are mixed at at least two kinds of mixing ratios and polymerized are measured. After that, the integral values in the above-mentioned calibration range are compared to provide a calibration curve for each of the (meth)acrylic monomers and/or (meth)acrylic oligomers.

(7) The surface layer of the photosensitive member to be identified is analyzed by infrared absorption spectroscopy. The mixing ratio of each of the (meth)acrylic monomers and/or (meth)acrylic oligomers in the surface layer is calculated from an obtained infrared absorption spectrum-1, and the calibration curve of each of the (meth)acrylic monomers and/or (meth)acrylic oligomers.

(8) An infrared absorption spectrum-2 of a polymer prepared by mixing and polymerizing each of the (meth)acrylic monomers and/or (meth)acrylic oligomers at the above-mentioned mixing ratio is measured.

(9) The infrared absorption spectrum-1 and the infrared absorption spectrum-2 are compared to each other. In this case, whether or not the integral value of a difference spectrum in the calibration range of each of the (meth)acrylic monomers and/or (meth)acrylic oligomers is 10% or less of the integral value in the calibration range of the infrared absorption spectrum-2 is recognized.

The procedures (1) and (2) in the above-mentioned identification method may be replaced by component identification using another method including literature search. In addition, it only needs to be recognized that the surface layer to be identified has been certainly polymerized from a plurality of kinds of (meth)acrylic monomers and/or (meth)acrylic oligomers that are candidates for identification finally in the above-mentioned procedure (9). Only in this case, the procedures (3) to (8) in addition to the procedures (1) and (2) may also be replaced by another method.

### <Identification Method for Metal Oxide Particle>

The fact that the surface layer of the electrophotographic photosensitive member to be used in the present disclosure contains a metal oxide particle, the composition of the metal oxide particle, and the content ratio of the metal oxide particle to the surface layer may be identified as described below.

### (Identification of Composition)

(1) A cross-section of the surface layer of the photosensitive member is cut out and observed with a scanning electron microscope.
(2) The composition of the particle present in an observation range is identified by subjecting the particle to energy-dispersive X-ray analysis.

### (Identification of Content Ratio)

(1) The photosensitive member is immersed in chloroform. The surface layer formed by polymerizing (meth)acrylic compounds is insoluble in chloroform. Because of this, the surface layer is separated from the photosensitive member in chloroform. (2) The separated surface layer is washed and then dried, and is subjected to thermogravimetric analysis.
(3) The content ratio is identified by comparing the weight at the time of low temperature to the weight after the entire organic substance is burnt at the time of high temperature.

### <Measurement Method for Volume Resistivity of Metal Oxide Particle>

The volume resistivity of the metal oxide particle may be evaluated by measuring the electrostatic capacitances and electroconductivities of air and powder by impedance measurement using a parallel-plate capacitor method.

As apparatus, a powder measurement jig including a four-terminal sample holder SH2-Z (manufactured by Toyo Corporation) and a torque wrench adapter SH-TRQ-AD (manufactured by Toyo Corporation, optional), and a material test system ModuLab XM MTS (manufactured by Solartron) are used. In addition, Noisecuttrans NCT-I3 1.4 kVA (manufactured by Denkenseiki Research Institute Co., Ltd.) for suppressing a commercial power supply noise and a shield box for suppressing an electromagnetic noise are used.

The four-terminal sample holder and the torque wrench adapter SH-TRQ-AD serving as an option are used in the powder measurement jig. An upper electrode (Φ25 mm solid electrode) SH-H25AU and a lower electrode for a liquid/powder (center electrode Φ10 mm; guard electrode Φ26 mm) SH-2610AU are used as parallel-plate electrodes. Thus, a configuration in which a resistance of from 0.1Ω to 1 TΩ may be measured with respect to an electrical signal up to 500 Vp-p, DC to AC 1 MHz, may be adopted. In addition, in order to adjust the pressure of a powder sample, the torque wrench adapter SH-TRQ-AD is mounted on a micrometer used for the measurement of the thickness between the upper and lower electrodes, which are arranged on the four-terminal sample holder. Torque drivers RTD15CN and RTD30CN (manufactured by Tonichi Mfg. Co., Ltd.), and a 6.35 mm rectangular bit are used as torque drivers to be used for pressure management. Thus, a configuration that can manage the tightening torque of the metal oxide particle to 20.0 cN/m is adopted.

In the measurement of electrical AC characteristics, impedance measurement is performed with a material test system ModuLab XM MTS (manufactured by Solartron). ModuLab XM MTS includes a control module XMMAT 1 MHz, a high-voltage module XMMHV100, a FEMTO current module XMMFA, and a frequency response analysis module XMMRA 1 MHz. In addition, XM-studio MTS Ver. 3.4 manufactured by Solartron is used as control software.

Measurement conditions for the metal oxide particle are as follows. NormalMode in which only the measurement is performed is adopted. In addition, an AC level is set within the range of from 7×10⁻³ to 7 Vrms so that a current range region that may be measured with a measurement device is achieved. In addition, a DC bias is set to 0 V, and a sweep frequency is set to from 1 MHz to 0.01 Hz (12 points/decade or 6 points/decade). In addition, in a case where a powder material having high electroconductivity such as an external additive is adopted, the AC level is set within the range of from 7×10⁻³ to 7 Vrms so that a current range region that may be measured with the measurement device is achieved.

Further, in consideration of the suppression of the noise and the shortening of the measurement time period, the following settings are added to every sweep frequency.

Sweep frequency of from 1 MHz to 10 Hz: measurement integration time of 64 cycles

Sweep frequency of from 10 Hz to 1 Hz: measurement integration time of 24 cycles

Sweep frequency of from 1 Hz to 0.01 Hz: measurement integration time of 1 cycle

Under the measurement conditions as described above, the measurement of impedance characteristics serving as electrical AC characteristics is performed.

When the measurement is performed under the above-mentioned conditions, impedance characteristics of air and the sample at a thickness “d” in accordance with a measurement electrode S having Φ10 mm and a pressure torque is obtained by using the powder measurement jig based on the parallel-plate capacitor method.

The measurement system is subjected to data correction processing from the obtained impedance characteristics of air and the sample to obtain an electrostatic capacitance C and a conductance (electroconductivity) G each having high reliability. A specific dielectric constant and an electroconductivity serving as electric properties are determined from the obtained electrostatic capacitance C and conductance (electroconductivity) G, and a geometric shape (a size S of each of the parallel-plate electrodes and a sample thickness) of the powder measurement jig.

When the four-terminal sample holder SH2-Z is used for the first time, the four-terminal sample holder SH2-Z to be used for the powder measurement jig has individual differences, and hence in order to find out optimal measurement conditions, the following two verifications are required to be performed. The first verification is thickness dependency characteristics of the four-terminal sample holder. The dependency on the thickness of air (distance between upper and lower electrodes) is measured to recognize an error between the theoretical value and measured value of the electrostatic capacitance. Thus, a thickness in which an optimal range or an optimal value where the measurement error becomes minimum is achieved is grasped. The second verification is the measurement of a mechanical error. In the measurement of the powder sample, a load having been subjected to torque management is applied in order to keep a volume density constant. In contrast, the measurement of air is performed in a no-load state. In this case, a thickness error is caused by an influence of a dimension such as mechanical processing accuracy. Thus, offset values of a tightening torque management value (6.5 cN-m in this jig) in the load state and the no-load state are identified, and the values are each defined as an offset correction value.

A specific production and measurement procedure of the sample is as follows. (1) The powder sample is placed on a center electrode portion of the lower electrode, and the sample is formed to have a trapezoidal shape having a height of 5 mm. (2) The lower electrode on which the powder sample is placed is mounted on the four-terminal sample holder SH2-Z to lower the upper electrode. (3) In this case, the upper electrode is lowered to an upper end portion of the powder sample while being kept horizontal so as not to be unintentionally rotated. (4) Smooth processing is performed while the upper electrode is horizontally rotated so that the powder sample becomes smooth. (5) While the powder sample is adjusted to have a predetermined thickness with a micrometer, a rotating direction of the upper electrode is kept being a uniform constant direction. (6) A pressure is applied with a torque driver having a tightening torque managed to 20.0 cN-m. (7) The thickness of the powder sample is measured with the micrometer. (8) Impedance measurement is performed under the above-mentioned conditions. (9) After the completion of the measurement, the upper electrode is raised, and the lower electrode is removed. In this case, the lower electrode is removed while satisfactory attention is paid so that the powder sample does not enter a contact terminal for a lower electrode of the four-terminal sample holder, followed by the protection of the resultant with a masking tape. (10) The upper and lower electrodes are washed. (11) The masking tape is removed, and the lower electrode is mounted thereon. (12) The sample thickness “d” determined in the step (7) is adjusted to have a thickness “t” of air in consideration of the offset correction in the no-load state, and the rotating direction of the upper electrode is kept being a uniform constant direction. (13) Impedance measurement for air is performed. (14) When the measurement data (dielectric loss tangent; tan δ) of air measured in the step (13) is larger than 0.001 in a frequency region of from 100 Hz to 0.021 Hz, the washing is insufficient, and hence the operation is redone from the washing step in the step (10).

The measurement is performed at 25° C.

A specific data processing procedure is as follows. (15) From the measured impedance characteristics of air, an error of phase characteristics with respect to the theoretical value is calculated to provide phase correction data of the material test system ModuLab XM MTS (manufactured by Solartron). (16) The phase correction data calculated in the step (15) is applied to the impedance characteristics of air measured in the step (13) to provide the impedance characteristics of air subjected to the phase correction processing. (17) From an admittance Ya=Ga+jωCa of the impedance characteristics of air subjected to phase correction, an electrostatic capacitance Ca is calculated, and an error from the theoretical value is calculated to provide correction data a with respect to a thickness error. (18) The phase correction processing obtained in the step (15) is applied to the impedance characteristics of the powder sample measured in the step (8). (19) The specific dielectric constant and electroconductivity of the powder sample each having high reliability are obtained by calculating the complex admittance Ym=Gm+jωCm having characteristics subjected to the phase correction processing of the step (18) using the electrostatic capacitance Ca of air determined in the step (17) and the correction data a thereof.

A quantification method for the volume resistivity serving as an electric property is described below. (quantification method for an electroconductivity index κ/ω)

In general, an electroconductivity κ of a dielectric (insulator) has such a characteristic as to be proportional to an angular frequency, and hence it is useful to use an electroconductivity index κ/ω obtained by dividing the electroconductivity κ by an angular frequency ω for an electroconductivity parameter value. The electroconductivity index κ/ω shows the same frequency characteristics as those of the dielectric loss tangent tan δ, and when dielectric relaxations of an electrode interfacial component and a powder bulk component are different from each other, a characteristic having a local maximum value is obtained. It is conceivable that the local maximum value of the electroconductivity index κ/ω represents an electroconductivity with respect to a powder bulk including a particle interior, a particle surface, and a (particle-particle) interface. In view of the foregoing, the local maximum value is defined as the electroconductivity parameter of the powder bulk component.

### (Quantification Methods for Electroconductivity and Volume Resistivity)

The powder sample having both the electrostatic capacitance and the electroconductivity can be recognized as an RC parallel circuit model in which the electroconductivity κ shows a constant value in a low frequency region. A reciprocal of the electroconductivity κ is defined as the volume resistivity.

Next, the configuration of the developing roller to be used in the present disclosure is described in detail below.

### [Developing Roller]

Any developing roller typically used for developing an electrostatic latent image formed on the surface of a photosensitive member in an electrophotographic process may be used as the developing roller to be used in the present disclosure without any particular limitation. A developing roller including an electroconductive substrate and an elastic layer may be used as the developing roller. The developing roller may be specifically, for example, an elastic body roller having a configuration in which an electroconductive elastic rubber layer having a predetermined volume resistivity is arranged as the elastic layer on the periphery of a metal core made of a metal.

### <Electroconductive Substrate>

A columnar or hollow cylindrical electroconductive mandrel may be used as the electroconductive substrate. The electroconductive mandrel may be formed of the following electroconductive material. That is, examples of the electroconductive material include: a metal or an alloy, such as aluminum, a copper alloy, or stainless steel; iron subjected to plating treatment with chromium or nickel; and a synthetic resin having electroconductivity. A known adhesive may be appropriately applied to the surface of the electroconductive substrate for the purpose of improving its adhesive property with, for example, the elastic layer arranged on the outer periphery of the electroconductive substrate.

### <Elastic Layer>

The elastic layer is typically preferably formed of a molded body of a rubber material. Examples of the rubber material include an ethylene-propylene-diene copolymerized rubber (EPDM), an acrylonitrile-butadiene rubber (NBR), a chloroprene rubber (CR), a natural rubber (NR), an isoprene rubber (IR), a styrene-butadiene rubber (SBR), a fluororubber, a silicone rubber, an epichlorohydrin rubber, a hydrogenated product of NBR, and a urethane rubber. Those rubber materials may be used alone or in combination thereof.

The elastic layer may be one layer or may be formed of a plurality of layers. When the elastic layer is formed of a plurality of layers, the plurality of layers may include a plurality of layers formed of, out of the rubber materials described above, the materials identical to each other, or may include a plurality of layers formed of the materials different from each other.

From the viewpoint of suppressing a change in dynamic friction coefficient between the developing roller and the photosensitive member, the MD-1 hardness measured at a temperature of 23° C. for the outer surface of the developing roller may be 200 to 55°.

Electroconductivity may be imparted to the elastic layer by blending an electroconductivity-imparting agent, such as an electronic electroconductive substance or an ionic electroconductive substance.

Examples of the electronic electroconductive substance include: electroconductive carbons including carbon blacks, such as ketjen black EC and acetylene black, carbons for rubbers, such as super abrasion furnace (SAF), intermediate SAF (ISAF), high abrasion furnace (HAF), fast extruding furnace (FEF), general purpose furnace (GPF), semi-reinforcing furnace (SRF), fine thermal (FT), and medium thermal (MT), and carbons for colors (inks) each subjected to oxidation treatment; and metals, such as copper, silver, and germanium, and metal oxides thereof. Of those, electroconductive carbon is preferred because the electroconductivity can be easily controlled with a small amount.

Examples of the ionic electroconductive substance include: inorganic ionic electroconductive substances, such as sodium perchlorate, lithium perchlorate, calcium perchlorate, and lithium chloride; and organic ionic electroconductive substances, such as a modified aliphatic dimethylammonium ethosulfate and stearylammonium acetate.

Those electroconductivity-imparting agents are each appropriately blended in a required amount in accordance with the electroconductivity required in the elastic layer.

Various additives, such as particles, an electroconductive agent, a plasticizer, a filler, an extender, a crosslinking agent, a crosslinking accelerator, a vulcanization aid, a crosslinking aid, an acid acceptor, a curing inhibitor, an antioxidant, and an age inhibitor, may each be further incorporated into the elastic layer as required. Those optional components may each be blended in an amount in such a range that the features of the present disclosure are not impaired.

Examples of the crosslinking agent include sulfur-based crosslinking agents including sulfur, such as powdered sulfur, oil-treated powdered sulfur, precipitated sulfur, colloidal sulfur, or dispersible sulfur, and organic sulfur-containing compounds, such as tetramethylthiuram disulfide and N,N-dithiobismorpholine. The blending ratio of the sulfur is preferably 0.5 to 2.0 parts by mass per 100 parts by mass of the total amount of the rubber material in consideration of impartment of satisfactory characteristics as the rubber. In addition, when the organic sulfur-containing compound is used as the crosslinking agent, the amount of the organic sulfur-containing compound used is preferably adjusted so that the amount of sulfur in a molecule thereof is within the above-mentioned range.

Examples of the crosslinking accelerator for accelerating the crosslinking include a thiuram-based accelerator, a thiazole-based accelerator, a thiourea-based accelerator, a guanidine-based accelerator, a sulfenamide-based accelerator, and a dithiocarbamate-based accelerator. The crosslinking accelerator is blended in an appropriate amount in accordance with molding conditions and a vulcanization speed required for the shape of a molded product.

Examples of the crosslinking aid include hitherto known crosslinking aids including: metal compounds, such as zinc oxide; and fatty acids, such as stearic acid and oleic acid. When the crosslinking aid is used, the content ratio of the crosslinking aid is preferably 0.1 part by mass or more with respect to 100 parts by mass of the total amount of the rubber material, and is preferably 7.0 parts by mass or less with respect thereto.

The acid acceptor is used for: preventing a chlorine-based gas generated from, for example, an epichlorohydrin rubber or a CR at the time of the crosslinking from remaining inside the electrophotographic members of a finished product; and preventing, for example, crosslinking inhibition and contamination of other members caused by the remaining gas from occurring. Various substances each acting as an acid receptor may be used as the acid acceptor, and a hydrotalcite, which is excellent in dispersibility, is preferably used.

For example, zinc oxide, silica, carbon black, talc, calcium carbonate, magnesium carbonate, and aluminum hydroxide may each be used as the filler. The mechanical strength of a binder resin can be expected to be improved by blending any such filler. In addition, as described above, electronic electroconductivity may be imparted to an electrophotographic member by using electroconductive carbon black that functions as an electronic electroconductive agent as the filler. The filler is appropriately blended in a required amount in accordance with characteristics required for a molded body.

Next, the configuration of the toner-supplying roller to be used in the present disclosure is described in detail below.

### [Toner-Supplying Roller]

In the present disclosure, a roller including an electroconductive shaft body and a resin layer formed on the shaft body may be used as the toner-supplying roller.

### <Shaft Body>

The shaft body functions as a support member for the toner-supplying roller and an electrode. The shaft body includes an electroconductive material, such as: a metal or an alloy, such as aluminum, a copper alloy, or stainless steel; iron subjected to plating treatment with chromium or nickel; or a synthetic resin having electroconductivity. The shaft body has a solid columnar shape or a hollow cylindrical shape.

### <Resin Layer>

The resin layer preferably contains a crosslinked urethane resin described later from the viewpoint of strength.

In addition, to uniformly supply toner particles to the surface of the developing roller as the toner-supplying roller, the resin layer is preferably a foamed layer having a void that can store the toner particles in the layer. Examples of the void include a large number of through holes and non-through holes. In addition, another example of the void may be a porous form in a state in which bubbles are connected to each other (open cell). The foamed layer containing the crosslinked urethane resin is preferably in an open cell state having a large void. The physical property values of such foamed layer having a void, such as an average cell diameter on the surface thereof, the number of cells thereof, the airflow rate thereof, and the density of the entirety of the layer, are important for the function of the foamed layer. Although the physical property values of the foamed layer are not particularly limited, for example, the foamed layer preferably has values that fall within the following numerical ranges:
average cell diameter on surface: 100 to 500 μm;
number of cells: 50 to 300 cells/inch;
airflow rate: 0.5 to 3.0 L/min; and
density: 0.05 to 0.20 g/cm³.

### <Crosslinked Urethane Resin>

The crosslinked urethane resin is a reaction product between a polyol and a compound having an isocyanate group. Examples of the polyol used for synthesizing the crosslinked urethane resin include a polyester polyol, a polyether polyol, an acrylic polyol, a polycarbonate polyol, and a polycaprolactone polyol. Of those, a polyether polyol is preferred from the viewpoint of improving flexibility of the crosslinked urethane resin.

Examples of the polyether polyol include polyethylene glycol, polypropylene glycol, poly-1,4-butanediol, poly-1,5-pentanediol, polyneopentyl glycol, poly-3-methyl-1,5-pentanediol, poly-1,6-hexanediol, poly-1,8-octanediol, and poly-1,9-nonanediol. Of those, polypropylene glycol, poly-1,4-butanediol, poly-1,5-pentanediol, polyneopentyl glycol, poly-3-methyl-1,5-pentanediol, and poly-1,6-hexanediol are preferred from the viewpoint of suppressing an increase in hardness of the resin layer.

In addition, examples of the polyester polyol include polyester polyols obtained by a condensation reaction between: diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, or triol components such as trimethylolpropane; and dicarboxylic acids, such as adipic acid, suberic acid, sebacic acid, phthalic anhydride, terephthalic acid, and hexahydroxyphthalic acid. Of those, polyester polyols obtained by a condensation reaction between diol components, such as propylene glycol, 1,4-butanediol, 1,5-pentanediol, neopentyl glycol, 3-methyl-1,5-pentanediol, and 1,6-hexanediol, and dicarboxylic acids, such as adipic acid, suberic acid, and sebacic acid, are preferred from the viewpoint of suppressing the increase in hardness of the resin layer.

In addition, examples of the polycaprolactone polyol include poly-ε-caprolactone and poly-γ-caprolactone.

In addition, examples of the polycarbonate polyol include polycarbonate polyols obtained by a condensation reaction between diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, and dialkyl carbonates, such as phosgene and dimethyl carbonate, or cyclic carbonates such as ethylene carbonate. Of those, polycarbonate polyols obtained by a condensation reaction between diol components, such as neopentyl glycol, 3-methyl-1,5-pentanediol, 1,5-pentanediol, 1,6-hexanediol, and 1,8-octanediol, and dialkyl carbonates such as dimethyl carbonate are preferred from the viewpoint of suppressing the increase in hardness of the resin layer. Those polyol components may be turned into prepolymers subjected to chain extension in advance with an isocyanate compound, such as 2,4-tolylene diisocyanate (TDI), 4,4′-diphenylmethane diisocyanate (MDI), or isophorone diisocyanate (IPDI), as required.

### <Isocyanate Compound>

Although the isocyanate compound is not particularly limited, the following isocyanate compounds may each be used: aliphatic polyisocyanates, such as ethylene diisocyanate and 1,6-hexamethylene diisocyanate (HDI); alicyclic polyisocyanates, such as isophorone diisocyanate (IPDI), cyclohexane-1,3-diisocyanate, and cyclohexane-1,4-diisocyanate; aromatic isocyanates, such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, and naphthalene diisocyanate; and copolymers, isocyanurate forms, TMP adduct forms, biuret forms, and blocked forms thereof. Of those, aromatic isocyanates, such as tolylene diisocyanate and diphenylmethane diisocyanate, are preferred. It is preferred that the polyol component and the isocyanate compound be mixed so that the ratio (molar ratio) of an isocyanate group in the isocyanate compound falls within the range of from 1.0 to 2.0 with respect to 1.0 of a hydroxy group in the polyol component. When the mixing ratio falls within the above-mentioned range, the remaining of unreacted components can be suppressed.

### <Crosslinking Agent>

The resin layer preferably contains a crosslinking agent as a material for synthesizing the crosslinked urethane resin. Examples of the crosslinking agent include an isocyanate that is trifunctional or more and a polyol that is trifunctional or more, and a crosslinked structure may be formed by using these crosslinking agents. In addition, separately from the foregoing, a known crosslinking agent suitable for the urethane resin may be used. Examples of the known crosslinking agent suitable for the urethane resin include an amine-based crosslinking agent such as ethylenediamine and an imide-based crosslinking agent such as a carbodiimide.

### <Other Component in Resin Layer>

The resin layer may contain an electroconductive filler as required to the extent that the effects of the present disclosure are not impaired. Carbon black and an electroconductive metal, such as aluminum or copper, may each be used as the electroconductive filler. Of those, carbon black is particularly preferably used because the carbon black is relatively easily available, and has a high electroconductivity-imparting property and a high reinforcing property.

In the resin layer, a catalyst, a foaming agent, a foam stabilizer, and other aids may be used as required.

The catalyst is not particularly limited, and a catalyst appropriately selected from various hitherto known catalysts may be used. For example, an amine-based catalyst (e.g., triethylenediamine, bis(dimethylaminoethyl) ether, N,N,N′,N′-tetramethylhexanediamine, 1,8-diazabicyclo(5.4.0)undecene-7, 1,5-diazabicyclo(4.3.0)nonene-5, 1,2-dimethylimidazole, N-ethylmorpholine, or N-methylmorpholine), an organometallic catalyst (e.g., tin octylate, tin oleate, dibutyltin dilaurate, dibutyltin diacetate, titanium tetra-i-propoxide, titanium tetra-n-butoxide, or tetrakis(2-ethylhexyloxy)titanium), or an acid salt catalyst obtained by reducing the initial activity of each of the amine-based catalyst and the organometallic catalyst (e.g., a carboxylic acid salt, a formic acid salt, an octylic acid salt, or a boric acid salt) is used. The catalysts may be used alone or in combination thereof.

The foaming agent is not particularly limited, and a foaming agent appropriately selected from various hitherto known foaming agents may be used. In particular, water is suitably used as the foaming agent because the water reacts with a polyisocyanate to generate a carbon dioxide gas. In addition, even when another foaming agent and water are used in combination, the gist of the present disclosure is not impaired.

The foam stabilizer is not particularly limited, and a foam stabilizer appropriately selected from various hitherto known foam stabilizers may be used.

As required, a crosslinking aid, a flame retardant, a colorant, a UV absorber, an antioxidant, and the like may be used as the other aids to the extent that the effects of the present disclosure are not impaired.

### [Process Cartridge and Electrophotographic Apparatus]

The process cartridge according to the present disclosure is a process cartridge being detachably attachable onto a main body of an electrophotographic apparatus, and is characterized by including the electrophotographic photosensitive member, the developing roller, and the toner-supplying roller described in the foregoing. In the process cartridge, the developing roller is configured to develop an electrostatic latent image formed on the surface of the photosensitive member, and the toner-supplying roller is arranged in contact with the developing roller and is configured to supply toner to the developing roller.

In addition, an electrophotographic apparatus according to the present disclosure is characterized by including the above-mentioned process cartridge.

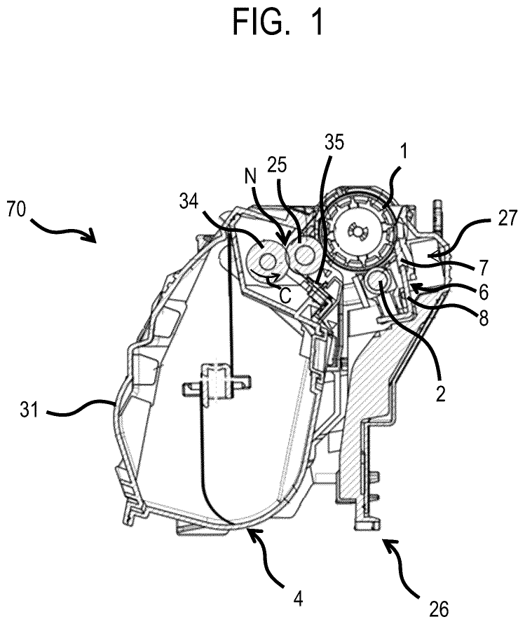

FIG. 1 is an illustration of an example of the main cross-section of a process cartridge 70 including a photosensitive member, a developing roller, and a toner-supplying roller.

The process cartridge 70 includes a photosensitive unit 26 and a developing unit 4. The photosensitive unit 26 includes a photosensitive drum 1, a charging roller 2, and a cleaning member 6. In addition, the developing unit 4 includes a developing roller 25 and a toner-supplying roller 34.

The charging roller 2 and the cleaning member 6 described above are arranged on the periphery of the photosensitive drum 1. The cleaning member 6 includes an elastic member 7 formed of a rubber blade and a cleaning support member 8. The distal end portion of the elastic member 7 is arranged in abutment against the photosensitive drum 1 in a counter direction with respect to the rotation direction thereof. In addition, the toner removed from the surface of the photosensitive drum 1 by the cleaning member 6 falls into a removed toner chamber 27.

The photosensitive drum 1 is rotationally driven in accordance with an image forming operation by transmitting the driving force of a main body drive motor (not shown), which is a drive source, to the photosensitive unit 26.

The charging roller 2 is rotatably mounted on the photosensitive unit 26 through intermediation of a charging roller bearing, is pressurized toward the photosensitive drum 1 by a charging roller-pressurizing member to be brought into abutment against the photosensitive drum 1, and is thus rotated following the rotation of the photosensitive drum 1.

The developing unit 4 includes the developing roller 25 that is rotated in contact with the photosensitive drum 1 and a developing frame 31 that supports the developing roller 25. The toner-supplying roller 34 that is rotated in the direction of the arrow C in contact with the developing roller 25 and a developing blade 35 for regulating a toner layer on the developing roller 25 are each arranged on the periphery of the developing roller 25.

The elastic layer of the developing roller may be formed of, for example, a base layer and a surface layer. In this case, a silicone rubber and a urethane rubber may be used for the base layer and the surface layer, respectively, and a desired roughness may be set by dispersing particles of urethane beads in the urethane rubber of the surface layer. The developing roller 25 and the photosensitive drum 1 are each rotated so that their surfaces move in the same direction in an opposed portion (contact portion). Toner negatively charged by frictional charging against a predetermined DC bias applied to the developing roller 25 is transferred only to a light portion potential portion based on its potential difference in a developing portion that is brought into contact with the photosensitive drum 1, to thereby visualize an electrostatic latent image.

The developing blade 35 is arranged below the developing roller 25 on the drawing sheet in which FIG. 1 is illustrated, and is in abutment against the developing roller 25 in a counter direction to regulate the coat amount of toner supplied by the toner-supplying roller 34 and apply charge to the toner. The developing blade 35 may include a plate member having flexibility and a developing blade support that fixes the plate member. In addition, the developing blade 35 may include an elastic plate formed by using stainless steel (SUS) or the like. The toner is frictionally charged by sliding between the developing blade 35 and the developing roller 25 to be given charge, and is simultaneously regulated for layer thickness. In addition, a predetermined voltage is applied to the developing blade 35 from a blade bias power supply (not shown) to stabilize the toner coat.

The toner-supplying roller 34 is in abutment against the developing roller 25 with a nip portion N. In the present disclosure, the toner-supplying roller 34 and the developing roller 25 are configured so that the movement direction of the surface of the toner-supplying roller 34 in the nip portion N and the movement direction of the surface of the developing roller 25 in the nip portion N are opposite to each other at the time of operation (rotation) (counter configuration). That is, the toner-supplying roller 34 and the developing roller 25 are configured so that the movement direction of the surface of the developing roller 25 is opposite to the movement direction of the surface of the toner-supplying roller 34 at a contact position with the toner-supplying roller 34. The toner-supplying roller 34 and the developing roller 25 are in contact with each other in a predetermined penetration amount, that is, a recessed amount ΔE of a recessed shape in the toner-supplying roller 34 formed by the developing roller 25. It is required that the toner-supplying roller 34 and the developing roller 25 be rotated with the following peripheral velocity difference in directions opposite to each other in the nip portion N. That is, the developing roller 25 and the toner-supplying roller 34 are configured to be rotated while R represented by the following formula (E1) satisfies 1.2≤R≤1.5.

$$R = {V}_{RS} / {V}_{D} \qquad ( E1 )$$

in the formula (E1), V_{RS} represents the absolute value of the peripheral velocity [m/s] of the toner-supplying roller 34, and V_{D} represents the absolute value of the peripheral velocity [m/s] of the developing roller 25.

Through this operation, toner supply to the developing roller 25 is performed while the residual toner on the developing roller 25 is recovered. In this case, the recovery amount of the residual toner on the developing roller 25 and the supply amount of the toner to the developing roller 25 can be adjusted by adjusting a potential difference between the toner-supplying roller 34 and the developing roller 25.

The toner-supplying roller 34 includes, for example, an electroconductive support serving as a shaft body and a foamed layer supported by the electroconductive support. Specifically, there may be arranged a metal core electrode having an outer diameter of φ5 (mm), the electrode serving as the electroconductive support, and a urethane foamed layer formed around the metal core electrode, the urethane foamed layer serving as the foamed layer including an open-cell foam (open cell) in which bubbles are connected to each other, and the toner-supplying roller 34 is rotated in the direction of the arrow C in the figure at the time of operation. A large amount of the toner is allowed to penetrate into the toner-supplying roller 34 by forming the urethane of the surface layer into an open-cell foam. The resistance of the toner-supplying roller 34 may be, for example, 1×10⁹Ω.

The penetration amount of the toner-supplying roller 34 into the developing roller 25, that is, the recessed amount ΔE of the recessed shape in the toner-supplying roller 34 formed by the developing roller 25 may be set to, for example, 1.0 mm.

A method of measuring the resistance of the toner-supplying roller 34 is described below. The toner-supplying roller 34 is brought into abutment against an aluminum sleeve having a diameter of 30 mm so that its penetration amount to be described later is 1.5 mm. The toner-supplying roller 34 is rotated following the aluminum sleeve at 30 rpm by rotating the aluminum sleeve.

Next, a DC voltage of −50 V is applied to the developing roller 25. In this case, a resistor of 10 kΩ is arranged on the ground side and a current is calculated by measuring a voltage across the resistor. Thus, the resistance of the toner-supplying roller 34 is calculated. The surface cell diameter of the toner-supplying roller 34 may be set to, for example, 50 to 1,000 μm.

Herein, the cell diameter refers to the average diameter of foamed cells in an arbitrary cross-section. The average diameter is obtained by first measuring the area of the largest foamed cell from the enlarged image of the arbitrary cross-section, converting the area into a diameter equivalent to a perfect circle to provide a maximum cell diameter, then removing the foamed cells each having a cell diameter equal to or less than ½ of the maximum cell diameter as noise, and then converting the remaining individual cell areas into individual cell diameters in the same manner to provide an average thereof.

The toner supplied from the toner-supplying roller 34 to the surface of the developing roller 25 is frictionally charged by sliding between the developing blade 35 and the developing roller 25 to be given charge, and is simultaneously regulated for layer thickness. After that, the toner is conveyed to the abutment portion (developing portion) between the photosensitive drum 1 and the developing roller 25, and is transferred only to the light portion potential portion. The residual toner remaining on the surface of the developing roller 25 is returned into a developing container again and is recovered from the surface of the developing roller 25 by the toner-supplying roller 34 to be stored in the toner-supplying roller 34.

A configuration for driving the developing roller 25 and the toner-supplying roller 34 preferably includes a driving force-receiving portion, a first driving force-transmitting portion, and a second driving force-transmitting portion. In this case, the driving force-receiving portion is configured to receive a driving force for driving the toner-supplying roller 34. In addition, the first driving force-transmitting portion is configured to transmit the driving force received by the driving force-receiving portion to the toner-supplying roller 34. In addition, the second driving force-transmitting portion is configured to transmit a driving force generated by drive of the toner-supplying roller 34 to the developing roller 25. When the rotational drive of the developing roller 25 is indirectly performed through the second driving force-transmitting portion in response to the input of a driving force from the outside, the second driving force-transmitting portion absorbs an abrupt frictional force fluctuation. This suppresses the coat amount of the toner on the developing roller 25 from becoming unstable (reference patent literature: Japanese Patent Application Laid-Open No. 2014-134787). Specifically, the developing roller 25 is in contact with both the toner-supplying roller 34 and the photosensitive drum 1, and hence any abrupt frictional force fluctuation that has occurred between the developing roller 25 and the photosensitive drum 1 influences the rotation of the toner-supplying roller 34 that is in contact with the developing roller 25. In addition, the coat amount of the toner supplied onto the developing roller 25 by the toner-supplying roller 34 may become unstable. In the above-mentioned preferred configuration, the toner-supplying roller 34 is first driven by the input of a driving force from the outside, and then the developing roller 25 is driven through the second driving force-transmitting portion. Thus, even when an abrupt frictional force fluctuation occurs between the developing roller 25 and the photosensitive drum 1, the toner-supplying roller 34 is driven with a driving force from the outside that is not influenced by the frictional force fluctuation, and the second driving force-transmitting portion absorbs the frictional force fluctuation. As a result, the toner-supplying roller 34 can stably supply the toner to the developing roller 25. The above-mentioned configuration that suppresses the phenomenon in which the abrupt frictional force fluctuation makes the coat amount of the toner unstable is suitable for suppressing banding at the time of repeated use in the present disclosure. The second driving force-transmitting portion may include a third driving force-transmitting portion, a fourth driving force-transmitting portion, and a fifth driving force-transmitting portion. In this case, the third driving force-transmitting portion is arranged in the end portion of the shaft body of the toner-supplying roller 34 and is configured to transmit a driving force generated by drive of the toner-supplying roller 34 to the fourth driving force-transmitting portion. In addition, the fourth driving force-transmitting portion is configured to transmit the driving force to the fifth driving force-transmitting portion by being driven with the driving force received from the third driving force-transmitting portion. In addition, the fifth driving force-transmitting portion is arranged in the end portion of the mandrel of the developing roller 25 and is configured to receive the driving force from the fourth driving force-transmitting portion to drive the developing roller 25.

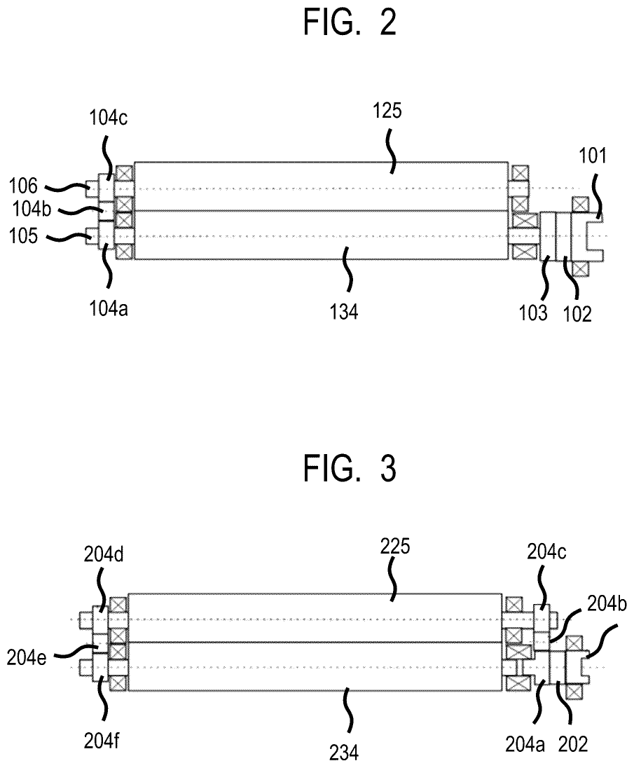

FIG. 2 is a schematic view for illustrating a specific example of a preferred configuration for driving the developing roller and the toner-supplying roller described above.

A driving force input to a coupling (driving force-receiving portion) 101 is transmitted to a driving force-transmitting member 103 through an intermediate 102 to drive a toner-supplying roller 134 rotationally. In this case, the combination of the intermediate 102 and the driving force-transmitting member 103 corresponds to the first driving force-transmitting portion described above. The rotational driving force transmitted to the toner-supplying roller 134 is transmitted to a gear (third driving force-transmitting portion) 104a, a gear (fourth driving force-transmitting portion) 104b, and a gear (fifth driving force-transmitting portion) 104c in this order to drive a developing roller 125 rotationally. In this case, the configuration formed of the combination of the gear 104a, the gear 104b, and the gear 104c corresponds to the second driving force-transmitting portion described above. That is, the gear 104a is arranged in the end portion of a shaft body 105 of the toner-supplying roller 134, and transmits a driving force generated by drive of the toner-supplying roller 134 to the gear 104b. Subsequently, the gear 104b is driven with the driving force received from the gear 104a to transmit the driving force to the gear 104c. In addition, the gear 104c is arranged in the end portion of a mandrel 106 of the developing roller 125, and receives the driving force from the gear 104b to drive the developing roller 125. As a result, the driving force generated by drive of the toner-supplying roller 134 is transmitted to the developing roller 125. In the example illustrated in FIG. 2, there is looseness in intermeshing portions among the gear 104a, the gear 104b, and the gear 104c, and hence the abrupt frictional force fluctuation that has occurred between the developing roller 125 and the photosensitive drum can be absorbed. In addition, the driving force transmitted from the outside to the toner-supplying roller 134 through the coupling 101, the intermediate 102, and the driving force-transmitting member 103 is not influenced by such frictional force fluctuation, and hence the toner-supplying roller 134 is stably driven. As a result, a fluctuation in supply amount of the toner from the toner-supplying roller 134 to the developing roller 125 can be suppressed.

The specific configuration of the second driving force-transmitting portion is not limited to the configuration formed of the combination of the gear 104a, the gear 104b, and the gear 104c illustrated in FIG. 2. The specific configuration of the second driving force-transmitting portion may be a configuration using any mechanism as long as the configuration is capable of transmitting the driving force generated by drive of the toner-supplying roller 134 to the developing roller 125.

In the preferred configuration for driving the developing roller 125 and the toner-supplying roller 134 described above, the above-mentioned R needs to satisfy 1.2≤R≤1.5. To that end, it is only required that the toner-supplying roller 134, the second driving force-transmitting portion, and the developing roller 125 be driven to be coupled as follows. That is, when the radius of the developing roller 125 is represented by r_{D} [mm], the radius of the toner-supplying roller 134 is represented by r_{RS} [mm] and λ is defined as the value represented by the following formula (E4), it is only required that the above-mentioned respective members be driven to be coupled so that the following formula (E5) is satisfied. In this case, λ represented by the following formula (E4) represents the ratio of a rotational angular velocity with respect to the radius r_{D} of the developing roller 125 and the radius r_{RS} of the toner-supplying roller 134:

$$λ = {ω}_{RS} / {ω}_{D} \qquad ( E4 )$$

in the formula (E4), ω_{RS} represents the rotational angular velocity [rad/s] of the toner-supplying roller 134, and ω_{D} represents the rotational angular velocity [rad/s] of the developing roller 125.

$$1.2 \leq λ \times {r}_{RS} / {r}_{D} \leq 1.5 \qquad ( E5 )$$

As an example, in the specific configuration illustrated in FIG. 2, it is only required that the three gear ratios of the gear 104a, the gear 104b, and the gear 104c be set so that the λ satisfies 1.2≤λ×r_{RS}/r_{D}≤1.5.

In addition, FIG. 3 is a schematic view for illustrating another example of the configuration for driving the developing roller and the toner-supplying roller.

A driving force input to a coupling 201 is transmitted to a gear 204a through an intermediate 202, and is transmitted to a gear 204b and a gear 204c in this order to drive a developing roller 225 rotationally. The rotational driving force is transmitted to a gear 204d, a gear 204e, and a gear 204f in this order to drive a toner-supplying roller 234 rotationally.

In the present disclosure, the above-mentioned R preferably satisfies 1.2≤R≤1.3 from the viewpoint of suppressing the solid density reduction at the time of the repeated use under the high-temperature and high-humidity environment, and the HT density reduction at the time of the repeated use under the low-temperature and low-humidity environment in a well-balanced manner.

The process cartridge according to the present disclosure may be used in, for example, a laser beam printer, an LED printer, and a copying machine.

### EXAMPLES

The present disclosure is described in more detail below by way of Examples and Comparative Examples. The invention is by no means limited to the following Examples without departing from the gist of the present disclosure. In the description of the following Examples, the term “part(s)” is “part(s) by mass” unless otherwise specified.

The thicknesses of the respective layers of electrophotographic photosensitive members produced in Examples and Comparative Examples except a charge generating layer were each determined by a method including using an eddy current-type thickness meter (Fischerscope (trademark), manufactured by Fischer Instruments K.K.) or a method including converting the mass of the layer per unit area into the thickness thereof through use of the specific gravity thereof. The thickness of the charge generating layer was determined as described below. That is, the Macbeth density value of the photosensitive member was measured by pressing a spectral densitometer (product name: X-Rite 504/508, manufactured by X-Rite Inc.) against the surface of the photosensitive member. Through use of a calibration curve obtained in advance from the Macbeth density value and the value of the thickness measured by the observation of a sectional SEM image of the layer, the thickness was calculated from the measured Macbeth density value.

### <Preparation of Coating Liquid for Charge Generating Layer>

### Synthesis Example

In 100 g of α-chloronaphthalene, 5.0 g of o-phthalodinitrile and 2.0 g of titanium tetrachloride were heated and stirred at 200° C. for 3 hours, and were then cooled to 50° C. to precipitate a crystal. The crystal was separated by filtration to provide a paste of dichlorotitanium phthalocyanine. Next, the paste was stirred and washed with 100 mL of N,N-dimethylformamide heated to 100° C., and was then washed repeatedly twice with 100 mL of methanol at 60° C. and separated by filtration. Further, the resultant paste was stirred at 80° C. for 1 hour in 100 mL of deionized water, and was separated by filtration to provide 4.3 g of a blue titanyl phthalocyanine pigment.

### [Milling Example]

0.5 Part of the titanyl phthalocyanine pigment obtained in Synthesis Example, 10 parts of tetrahydrofuran, and 15 parts of glass beads each having a diameter of 0.9 mm were subjected to milling treatment with a sand mill under a cooling water temperature of 18° C. for 48 hours. The sand mill used herein is a sand mill (K-800, manufactured by Igarashi Machine Production Co., Ltd. (currently changed to Aimex Co., Ltd.), disc diameter: 70 mm, number of discs: 5). At this time, the treatment was performed under such a condition that the discs were rotated 500 times per minute. The glass beads were removed by filtering the liquid thus treated with a filter (product number: N-NO. 125T, pore diameter: 133 μm, manufactured by NBC Meshtec Inc.). 30 Parts of tetrahydrofuran was added to the resultant liquid, and then the mixture was filtered, followed by sufficient washing of the filtration residue on the filter with methanol and water. Then, the washed filtration residue was dried in a vacuum to provide 0.45 part of a titanyl phthalocyanine pigment. The resultant pigment had a strong peak at a Bragg angle 20 of 27.2°±0.3° in an X-ray diffraction spectrum using a CuKα ray.

The following materials were prepared.
The titanyl phthalocyanine pigment obtained in Milling Example: 12 parts
Polyvinyl butyral (product name: S-LEC BX-1, manufactured by Sekisui Chemical Co., Ltd.): 10 parts
Cyclohexanone: 158 parts
Glass beads each having a diameter of 0.9 mm: 402 parts

Those materials were subjected to dispersion treatment with a sand mill (K-800, manufactured by Igarashi Machine Production Co., Ltd. (currently changed to Aimex Co., Ltd.), disc diameter: 70 mm, number of discs: 5) under a cooling water temperature of 18° C. for 4 hours. At this time, the treatment was performed under such a condition that the discs were rotated 1,800 times per minute. After the removal of the glass beads, 369 parts of cyclohexanone and 527 parts of ethyl acetate were added to the dispersion liquid to prepare a coating liquid for a charge generating layer.

### <Preparation of Coating Liquid for Charge Transporting Layer>

### [Preparation of Coating Liquid 1 for Charge Transporting Layer]

The following materials were prepared.
CTM9 serving as a charge transporting substance: 100 parts
Polycarbonate A resin having a structural unit represented by the following formula (A): 183 parts

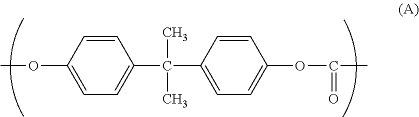

Polycarbonate Z resin having a structural unit represented by the following formula (Z): 183 parts

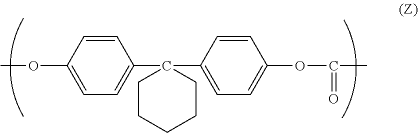

Siloxane resin (product name: DC200, manufactured by Dow Corning Toray Co., Ltd.): 0.03 part

Those components were dissolved in a mixed solvent of 1,400 parts of tetrahydrofuran and 600 parts of 1,4-dioxane to prepare a coating liquid 1 for a charge transporting layer.

### [Preparation of Coating Liquid 2 for Charge Transporting Layer]

A coating liquid 2 for a charge transporting layer was prepared in the same manner as that of the coating liquid 1 for a charge transporting layer except that 9 parts of a 30 wt % dispersion liquid of indium tin oxide particles (ITO particles) (manufactured by Sigma-Aldrich) serving as the metal oxide particles was added to the coating liquid 1 for a charge transporting layer.

### <Preparation of Coating Liquid for Protection Layer>

### [Preparation of Coating Liquid 1 for Protection Layer]

The following materials were prepared.
ACM2 serving as a (meth)acrylic compound (Ebecryl E8301, manufactured by Daicel-Allnex Ltd.): 100 parts
30 wt % dispersion liquid of indium tin oxide (ITO) particles serving as the metal oxide particles (manufactured by Sigma-Aldrich): 38 parts
Crosslinking ether-modified polymethylsiloxane having an acryloyl group (UV3500, manufactured by BYK): 0.16 part

Those components were dissolved in 420 parts of ethanol to prepare a coating liquid 1 for a protection layer.

A volume ratio of a solid content in the obtained coating liquid 1 for a protection layer is shown in Table 1-1 and Table 1-2. When the volume ratio of the solid content in the coating liquid 1 for a protection layer was calculated, the following values were used.
Specific gravity of the (meth)acrylic compound ACM2: 1.2 [g/cm³]
Specific gravity of the ITO particles: 7.1 [g/cm³]
Specific gravity of the crosslinking ether-modified polymethylsiloxane having an acryloyl group: 1.0 [g/cm³]

In Table 1-2, MOx1 to MOx4 represent different kinds of metal oxide particles. The ratios of the (meth)acrylic compounds shown in Table 1-1 represent the ratios of the respective (meth)acrylic compounds with respect to the total of all the (meth)acrylic compounds on a volume basis. In addition, the ratios of the metal oxide particles shown in Table 1-2 represent the ratios of the respective metal oxide particles with respect to the entirety of the surface layer on a volume basis.

TABLE 1-1

| Number of coating | Kind and ratio of (meth)acrylic compound | | | | | | | |
|---|---|---|---|---|---|---|---|---|
| liquid for | Free of charge | | | | Having charge | | | |
| protection | transporting function | | | | transporting function | | | |
| layer | Kind | Ratio | Kind | Ratio | Kind | Ratio | Kind | Ratio |
| 1 | ACM2 | 100% | — | 0% | — | 0% | — | 0% |
| 2 | ACM2 | 100% | — | 0% | — | 0% | — | 0% |
| 3 | ACM2 | 100% | — | 0% | — | 0% | — | 0% |
| 4 | ACM2 | 100% | — | 0% | — | 0% | — | 0% |
| 5 | ACM2 | 100% | — | 0% | — | 0% | — | 0% |
| 6 | ACM2 | 100% | — | 0% | — | 0% | — | 0% |
| 7 | ACM2 | 100% | — | 0% | — | 0% | — | 0% |
| 8 | ACM2 | 100% | — | 0% | — | 0% | — | 0% |
| 9 | ACM2 | 100% | — | 0% | — | 0% | — | 0% |
| 10 | ACM2 | 100% | — | 0% | — | 0% | — | 0% |
| 11 | ACM2 | 100% | — | 0% | — | 0% | — | 0% |
| 12 | ACM2 | 100% | — | 0% | — | 0% | — | 0% |
| 13 | ACM2 | 100% | — | 0% | — | 0% | — | 0% |
| 14 | ACM2 | 100% | — | 0% | — | 0% | — | 0% |
| 15 | ACM2 | 100% | — | 0% | — | 0% | — | 0% |
| 16 | ACM2 | 100% | — | 0% | — | 0% | — | 0% |
| 17 | ACM2 | 100% | — | 0% | — | 0% | — | 0% |
| 18 | ACM2 | 100% | — | 0% | — | 0% | — | 0% |
| 19 | ACM2 | 100% | — | 0% | — | 0% | — | 0% |
| 20 | ACM2 | 100% | — | 0% | — | 0% | — | 0% |
| 21 | ACM2 | 100% | — | 0% | — | 0% | — | 0% |
| 22 | ACM2 | 100% | — | 0% | — | 0% | — | 0% |
| 23 | ACM2 | 100% | — | 0% | — | 0% | — | 0% |
| 24 | ACM2 | 100% | — | 0% | — | 0% | — | 0% |
| 25 | ACM2 | 100% | — | 0% | — | 0% | — | 0% |
| 26 | ACM1 | 100% | — | 0% | — | 0% | — | 0% |
| 27 | ACM3 | 100% | — | 0% | — | 0% | — | 0% |
| 28 | ACM4 | 100% | — | 0% | — | 0% | — | 0% |
| 29 | ACM19 | 100% | — | 0% | — | 0% | — | 0% |
| 30 | ACM2 | 50% | ACM19 | 50% | — | 0% | — | 0% |
| 31 | ACM2 | 50% | — | 0% | ACM27 | 50% | — | 0% |
| 32 | — | 0% | — | 0% | ACM27 | 100% | — | 0% |
| 33 | — | 0% | — | 0% | ACM28 | 100% | — | 0% |
| 34 | — | 0% | — | 0% | ACM29 | 100% | — | 0% |
| 35 | — | 0% | — | 0% | ACM25 | 100% | — | 0% |
| 36 | — | 0% | — | 0% | ACM28 | 50% | ACM33 | 50% |
| 37 | — | 0% | — | 0% | ACM25 | 50% | ACM29 | 50% |
| 38 | ACM2 | 25% | — | 0% | ACM27 | 50% | ACM33 | 25% |
| 39 | — | 0% | — | 0% | ACM27 | 100% | — | 0% |
| 40 | ACM2 | 100% | — | 0% | — | 0% | — | 0% |
| 41 | ACM2 | 100% | — | 0% | — | 0% | — | 0% |
| 42 | ACM2 | 100% | — | 0% | — | 0% | — | 0% |
| 43 | ACM2 | 100% | — | 0% | — | 0% | — | 0% |

TABLE 1-2

| Number | | | | | | | | |
|---|---|---|---|---|---|---|---|---|
| of coating | | | | | | | | |
| liquid for | Kind and ratio of metal oxide particles | | | | | | | |
| protection | MOx1 | | MOx2 | | MOx3 | | MOx4 | |
| layer | Kind | Ratio | Kind | Ratio | Kind | Ratio | Kind | Ratio |
| 1 | ITO | 1.9% | — | 0% | — | 0% | — | 0% |
| 2 | ITO | 0.1% | — | 0% | — | 0% | — | 0% |
| 3 | ITO | 1.0% | — | 0% | — | 0% | — | 0% |
| 4 | ITO | 4.8% | — | 0% | — | 0% | — | 0% |
| 5 | SnO | 1.9% | — | 0% | — | 0% | — | 0% |
| 6 | SnO | 4.8% | — | 0% | — | 0% | — | 0% |
| 7 | TiO₂ | 1.9% | — | 0% | — | 0% | — | 0% |
| 8 | TiO₂ | 4.8% | — | 0% | — | 0% | — | 0% |
| 9 | ZnO | 1.9% | — | 0% | — | 0% | — | 0% |
| 10 | ZnO | 4.8% | — | 0% | — | 0% | — | 0% |
| 11 | Al₂O₃ | 1.9% | — | 0% | — | 0% | — | 0% |
| 12 | Al₂O₃ | 4.8% | — | 0% | — | 0% | — | 0% |
| 13 | SrTiO₃ | 1.9% | — | 0% | — | 0% | — | 0% |
| 14 | SrTiO₃ | 4.8% | — | 0% | — | 0% | — | 0% |
| 15 | ZrO₂ | 1.9% | — | 0% | — | 0% | — | 0% |
| 16 | ZrO₂ | 4.8% | — | 0% | — | 0% | — | 0% |
| 17 | ITO | 1.0% | SnO | 3.8% | — | 0% | — | 0% |
| 18 | ITO | 1.0% | Al₂O₃ | 3.8% | — | 0% | — | 0% |
| 19 | ITO | 1.0% | SrTiO₃ | 3.8% | — | 0% | — | 0% |
| 20 | SnO | 1.0% | TiO₂ | 3.8% | — | 0% | — | 0% |
| 21 | SnO | 1.0% | Al₂O₃ | 3.8% | — | 0% | — | 0% |
| 22 | SnO | 1.0% | Al₂O₃ | 3.8% | — | 0% | — | 0% |
| 23 | ITO | 1.0% | SnO | 1.9% | Al₂O₃ | 1.9% | — | 0% |
| 24 | SnO | 1.0% | TiO₂ | 1.9% | Al₂O₃ | 1.9% | — | 0% |
| 25 | ITO | 1.0% | SnO | 1.0% | TiO₂ | 1.0% | Al₂O₃ | 1.9% |
| 26 | ITO | 1.9% | — | 0% | — | 0% | — | 0% |
| 27 | ITO | 1.9% | — | 0% | — | 0% | — | 0% |
| 28 | ITO | 1.9% | — | 0% | — | 0% | — | 0% |
| 29 | ITO | 1.9% | — | 0% | — | 0% | — | 0% |
| 30 | ITO | 1.9% | — | 0% | — | 0% | — | 0% |
| 31 | ITO | 1.9% | — | 0% | — | 0% | — | 0% |
| 32 | ITO | 1.9% | — | 0% | — | 0% | — | 0% |
| 33 | ITO | 1.9% | — | 0% | — | 0% | — | 0% |
| 34 | ITO | 1.9% | — | 0% | — | 0% | — | 0% |
| 35 | ITO | 1.9% | — | 0% | — | 0% | — | 0% |
| 36 | ITO | 1.9% | — | 0% | — | 0% | — | 0% |
| 37 | ITO | 1.9% | — | 0% | — | 0% | — | 0% |
| 38 | ITO | 1.9% | — | 0% | — | 0% | — | 0% |
| 39 | SrTiO3 | 1.9% | — | 0% | — | 0% | — | 0% |
| 40 | — | 0% | — | 0% | — | 0% | — | 0% |
| 41 | ITO | 0.1% | — | 0% | — | 0% | — | 0% |
| 42 | ITO | 0.1% | — | 0% | — | 0% | — | 0% |
| 43 | ITO | 0.1% | — | 0% | — | 0% | — | 0% |

### [Preparation of Coating Liquids 2 to 43 for Protection Layers]

Coating liquids 2 to 43 for protection layers were prepared in the same manner as in the preparation of the coating liquid 1 for a protection layer except that, in the preparation of the coating liquid 1 for a protection layer, the kinds and ratios of the (meth)acrylic compound and metal oxide particles to be added were changed as shown in Table 1-1 and Table 1-2.

The results of the measurement of volume resistivities of the respective metal oxide particles used in Table 1-2 in accordance with the section <Measurement Method for Volume resistivity of Metal Oxide Particles> are shown in Table 2.

In each of Table 1-2 and Table 2, “ITO” represents “indium tin oxide,” “SnO” represents “tin(II) oxide,” “TiO₂” represents “titanium(IV) oxide (titania),” “ZnO” represents “zinc oxide,” “Al₂O₃” represents “aluminum oxide (alumina),” “SrTiO₃” represents “strontium titanate,” and “ZrO₂” represents “zirconium dioxide (zirconia).”

TABLE 2

| Kind of | |
|---|---|
| MOx | Volume resistivity [Ω · cm] |
| ITO | 1.2 × 10⁻¹ |
| SnO | 5.4 × 10³ |
| TiO₂ | 3.8 × 10⁸ |
| ZnO | 8.1 × 10⁸ |
| Al₂O₃ | 6.3 × 10⁷ |
| SrTiO₃ | 1.7 × 10¹² |
| ZrO₂ | 8.1 × 10¹³ |

### <Production of Electrophotographic Photosensitive Member>

### (Photosensitive Member Production Example 1)

An aluminum cylinder (JIS-A3003, aluminum alloy) having a length of 257 mm and a diameter of 24 mm was prepared, which was produced by a production method including an extruding step and a drawing step. The cylinder was subjected to cutting processing through use of a diamond sintered cutting tool.

In a washing step, the cylinder was subjected to degreasing treatment, etching treatment in a 2 mass % sodium hydroxide solution for 1 minute, neutralization treatment, and washing with pure water in the stated order.

Next, the resultant was subjected to anodization in a 10 mass % sulfuric acid solution at a current density of 1.0 A/dm² for 20 minutes, to thereby form an anodized film on the surface of the cylinder. Then, after washing with water, the resultant was subjected to sealing treatment by being immersed in a 1 mass % nickel acetate solution at 80° C. for 15 minutes. Further, washing with pure water and drying treatment were performed to obtain an anodization-treated support.

The coating liquid for a charge generating layer was applied onto the support by dip coating to form a coating film, and the coating film was dried by heating at 100° C. for 15 minutes to form a charge generating layer having a thickness of 0.24 μm.

Next, the coating liquid 1 for a charge transporting layer was applied onto the above-mentioned charge generating layer by dip coating to form a coating film, and the coating film was dried by heating at 120° C. for 1 hour to form a charge transporting layer having a thickness of 18 μm.

Next, the coating liquid 1 for a protection layer was applied onto the above-mentioned charge transporting layer by dip coating to form a coating film. The coating film was irradiated with electron beams having a dose of 86 kGy. In the air, the coating film was naturally cooled until its temperature became 25° C. After that, heating treatment was performed for 1 hour under such a condition that the temperature of the coating film became 120° C. to form a protection layer having a thickness of 1.5 μm.

The heating treatment of the coating film of each layer was performed with an oven set to each temperature. Thus, a cylindrical (drum-shaped) photosensitive member 1 was produced.

### (Photosensitive Member Production Examples 2 to 43)

Photosensitive members 2 to 43 were produced in the same manner as in Photosensitive Member Production Example 1 except that in Photosensitive Member Production Example 1, the kind of the coating liquid for a protection layer to be used was changed to the coating liquids 2 to 43 for protection layers.

### (Photosensitive Member Production Example 44)

A photosensitive member 44 was produced in the same manner as in Photosensitive Member Production Example 1 except that in Photosensitive Member Production Example 1, the coating liquid 1 for a charge transporting layer was changed to the coating liquid 2 for a charge transporting layer, and the protection layer was not formed.

### <Production of Developing Roller 1>

### (Preparation of Substrate)

A mandrel made of stainless steel (SUS304) having an outer diameter of 6 mm and a length of 270 mm was prepared, and an electroconductive vulcanizing adhesive (product name: METALOC U-20, manufactured by Toyokagaku Kenkyusho Co., Ltd.) was applied to the circumferential surface of the mandrel, followed by baking. Thus, a mandrel serving as a substrate was prepared.

### (Formation of First Elastic Layer)

Materials for elastic layers shown in Table 3 were mixed at a filling ratio of 70 vol % and a blade rotation speed of 30 rpm for 16 minutes with a 6-liter pressure kneader (product name: TD6-15MDX, manufactured by TOSHIN Co., Ltd.) to provide a mixture A.

TABLE 3

| | Part(s) |
|---|---|
| Material | by mass |
| Acrylonitrile-butadiene rubber (NBR) | 60 |
| (product name: N230SV, manufactured by JSR Corporation) | |
| Epichlorohydrin rubber | 40 |
| (product name: EPION 301, manufactured by Osaka Soda | |
| Co., Ltd.) | |
| Zinc oxide (particle diameter: 0.28 μm, manufactured by Sakai | 5 |
| Chemical Industry Co., Ltd.) | |
| Calcium carbonate | 20 |
| (product name: NANOX #30, manufactured by Maruo Calcium | |
| Co., Ltd.) | |
| Carbon black | 40 |
| (product name: TOKABLACK #7400, manufactured by Tokai | |
| Carbon Co., Ltd.) | |

Then, materials shown in Table 4 were bilaterally cut 20 times in total at a front roll rotation speed of 10 rpm, a back roll rotation speed of 8 rpm, and a roll gap of 2 mm with an open roll having a roll diameter of 12 inches (0.30 m). After that, the resultant was subjected to tight milling 10 times at a roll gap of 0.5 mm to provide a mixture B.

TABLE 4

| | Part(s) |
|---|---|
| Material | by mass |
| Mixture A | 200 |
| Sulfur | 1.2 |
| Tetrabenzylthiuram disulfide | 4.5 |
| (product name: NOCCELER TBzTD, manufactured | |
| by Ouchi Shinko Chemical Industrial Co., Ltd.) | |

Next, the above-mentioned mixture B was extruded simultaneously with the mandrel while being molded into a cylindrical shape coaxially around the mandrel by extrusion molding using a crosshead. Thus, a layer of the mixture B was formed on the outer peripheral surface of the mandrel. An extruder having a cylinder diameter of 45 mm (Φ45) and an L/D of 20 was used as an extruder, and the temperatures of a head, a cylinder, and a screw at the time of the extrusion were adjusted to 90° C., 90° C., and 90° C., respectively. Both the end portions of the layer of the mixture B in the longitudinal direction of the mandrel were cut so that the length of the layer of the mixture B in the longitudinal direction of the mandrel was set to 237 mm.

After that, the mandrel was heated in an electric furnace at a temperature of 160° C. for 40 minutes so that the layer of the mixture B was vulcanized. Thus, a vulcanized member was formed. Subsequently, the surface of the vulcanized member was polished with a polishing machine of a plunge-cut grinding mode. Thus, a roller in which a first elastic layer having a thickness of 3.0 mm was formed on the outer periphery of a metal core was obtained.

### (Formation of Second Elastic Layer)

Materials except roughness-forming particles in Table 5 were stirred and mixed as materials for a second elastic layer. After that, the materials were dissolved in methyl ethyl ketone (manufactured by Kishida Chemical Co., Ltd.) so that their solid content concentration was 30 mass %, and the materials were mixed, followed by uniform dispersion with a sand mill. Methyl ethyl ketone was added to the mixed liquid to adjust the solid content concentration to 25 mass %, and a material shown in the “Roughness-forming particles” column in Table 5 was added to the resultant mixture, followed by stirring and dispersion with a ball mill. Thus, a coating liquid for a second elastic layer was obtained. The coating liquid was applied to the roller having the first elastic layer formed thereon by dipping the roller into the coating liquid so that the thickness of the second elastic layer was about 15 μm. After that, the coating film was dried and cured by heating at a temperature of 135° C. for 60 minutes to form a second elastic layer. Thus, a developing roller 1 was obtained.

TABLE 5

| | Part(s) |
|---|---|
| Material | by mass |
| Polyether Polyol | 100 |
| (product name: PTGL1000, manufactured by Hodogaya | |
| Chemical Co., Ltd.) | |
| Polymeric MDI | 36.0 |
| (product name: MR-400, manufactured by Tosoh Corporation) | |
| Carbon Black | 29.3 |
| (product name: SUNBLACK X15, manufactured by Asahi | |
| Carbon Co., Ltd.) | |
| Polyether Monool | 3.0 |
| (product name: NEWPOL 50HB100, manufactured by Sanyo | |
| Chemical Industries, Ltd.) | |
| Modified Silicone Oil | 0.6 |
| (product name: TSF4445, manufactured by Momentive | |
| Performance Materials Japan Llc) | |
| Roughness-forming particles | 104 |
| (product name: DAIMICBEAZ UCN-5090, manufactured by | |
| Dainichiseika Color & Chemicals Mfg. Co., Ltd.) | |

### (Analysis of Developing Roller 1)

The developing roller 1 was left to stand under an environment at a temperature of 23° C. and a relative humidity of 53% for 24 hours. Next, the hardness of the developing roller was measured with a microrubber hardness meter (product name: MD-1capa, manufactured by Kobunshi Keiki Co., Ltd.) and an indenter having a diameter of 0.16 mm at each of 12 points determined as follows: the central portion of the developing roller and positions distant inward from both the end portions thereof by 20 mm each were determined, and four points were determined in each of the three portions in increments of 90° in the circumferential direction thereof. The average of those measured values was adopted as an MD-1 hardness. The developing roller 1 showed an MD-1 hardness of 50°.

### <Production of Toner-supplying Roller 1>

A primer (product name: DY39-012, manufactured by Dow Corning Toray Co., Ltd.) was applied to a metal core made of stainless steel (SUS304) having a diameter of 5 mm, followed by baking, to prepare a shaft body.

In addition, a urethane rubber composition obtained by blending the following materials (A) to (F) and mixing the blended materials was foamed by a mechanical frothing method to produce a polyurethane foam.

The polyurethane foam was cut out into a 19-millimeter square rectangular parallelepiped shape having a length of 220 mm, and a shaft body insertion hole having a diameter of Φ5 mm was formed at the center of the 19-millimeter square surface along a longitudinal direction.

The shaft body was press-fitted into the shaft body insertion hole, and the shaft body and the polyurethane foam were bonded to each other by heat welding.

After that, the outer periphery of the polyurethane foam was polished with a traverse-type processing machine. Thus, an electroconductive roll having an outer diameter of 13 mm was produced.
(A): Carbon black (Ketjen Black 600JD): 5.0 parts by mass
(B): Polyol A (polyethylene propylene ether triol having a number average molecular weight of 2,000, product name: ACTCOL EP-550N, manufactured by Mitsui Chemicals, Inc.): 100.0 parts by mass
(C): Polyisocyanate mixture (NCO %=45, MDI=20% content, product name: COSMONATE TM20, manufactured by Mitsui Chemicals, Inc.): 24.4 parts by mass
(D): Silicone foam stabilizer (product name: SRX274C, manufactured by Dow Corning Toray Silicone Co., Ltd.): 1.0 part by mass
(E): Tertiary amine catalyst A (mixture of bis(2-dimethylaminoethyl) ether and dipropylene glycol, product name: TOYOCAT-ET, manufactured by Tosoh Corporation): 0.3 part by mass
(F): Amine catalyst B (product name: TOYOCAT-L33, manufactured by Tosoh Corporation): 0.2 part by mass

### [Evaluation]

### <Process Cartridge Used for Evaluation>

Each of the above-mentioned photosensitive members 1 to 44, the developing roller 1, and the toner-supplying roller 1 were mounted on the process cartridge as schematically illustrated in FIG. 1.

The following 7 kinds of process cartridges were each prepared as the process cartridge on which each of the above-mentioned photosensitive members was mounted.

First, the coupling 101, the intermediate 102, the driving force-transmitting member 103, and the gears 104a to 104c were arranged as illustrated in FIG. 2. Thus, a driving force was configured to be input to the end portion of the shaft body 105 of the toner-supplying roller 134. In addition, the developing roller 125 and the toner-supplying roller 134 were configured so that the movement direction of the surface of the developing roller 125 and the movement direction of the surface of the toner-supplying roller 134 were opposite to each other at a contact position between the developing roller 125 and the toner-supplying roller 134 (counter configuration). Further, to set R determined by a ratio between the peripheral velocity V_{D} of the developing roller 125 and the peripheral velocity V_{RS} of the toner-supplying roller to an intended value, the gear ratios of the respective gears 104a to 104c, the radius r_{D} of the developing roller 125, and the radius r_{RS} of the toner-supplying roller 134, the gears and the rollers being illustrated in FIG. 2, were appropriately set. Specifically, there were prepared five kinds of process cartridges in which the respective values were set so that the R had the following five kinds of values: 1.15, 1.25, 1.40, 1.50, and 1.60.

Next, in the same manner as that described above, a driving force was configured to be input to the end portion of the shaft body 105 of the toner-supplying roller 134 as illustrated in FIG. 2. In addition, in the configuration illustrated in FIG. 2, the number of the gears to be used was changed. Thus, the movement direction of the surface of the developing roller 125 and the movement direction of the surface of the toner-supplying roller 134 were set to be identical with each other at the contact position between the developing roller 125 and the toner-supplying roller 134 (hereinafter referred to as “with configuration”). Further, the gear ratios of the respective gears (not shown), the radius r_{D} of the developing roller, and the radius r_{RS} of the toner-supplying roller were set so that the R determined by the ratio between the peripheral velocity V_{D} of the developing roller and the peripheral velocity V_{RS} of the toner-supplying roller was an intended value. Specifically, there were prepared two kinds of process cartridges in which the respective values were set so that the R had the following two kinds of values: 1.15 and 1.25.

### <Evaluation>

A charging potential and an exposure potential were set to −550 V and −100 V, respectively, under an environment at a temperature of 32.5° C. and a relative humidity of 80%, and 100,000 sheets of a solid image made with a black toner were continuously passed (printed) (HH-solid density reduction endurance). In addition, separately from the foregoing, a charging potential and an exposure potential were set to −550 V and −100 V, respectively, under an environment at a temperature of 15° C. and a relative humidity of 10%, and 100,000 sheets of a one-dot knight-jump pattern halftone image made with the black toner were continuously passed (printed) (LL-HT density reduction endurance). In this case, a reconstructed machine of a laser beam printer manufactured by Hewlett-Packard Company was used as an electrophotographic apparatus. For the evaluation of this Example, specifically, for example, reconstructed machines of Color Laser Jet Enterprise M653dn (product name), Color Laser Jet Enterprise M553dn (product name), and Color Laser Jet CP4525dn (product name) may be used.

Each rank of the solid density reduction and the HT density reduction was determined by evaluating the image densities before and after the above-mentioned two kinds of endurance.

### (Solid Density Reduction)

In the passage of 100,000 sheets in the HH-solid density reduction endurance, the image densities of the solid images on the five sheets from the first sheet to the fifth sheet, and the image densities of the solid images on the five sheets from the 99,996th sheet to the 100,000th sheet were each measured with a Macbeth densitometer. After that, a difference between the average image density of the former five images and that of the latter five images was ranked in accordance with the following criteria.
A: The difference between the average image densities was less than 0.1.
B: The difference between the average image densities was 0.1 to less than 0.2.
C: The difference between the average image densities was 0.2 to less than 0.3.
D: The difference between the average image densities was 0.3 to less than 0.5.
E: The difference between the average image densities was 0.5 or more.

### (HT Density Reduction)

In the passage of 100,000 sheets in the LL-HT density reduction endurance, the image densities of the solid images on the five sheets from the first sheet to fifth sheet of the passage of 100,000 sheets, and the image densities of the solid images on the five sheets from the 99,996th sheet to 100,000th sheet thereof were each measured with a Macbeth densitometer. After that, a difference between the average image density of the former five images and that of the latter five images was ranked in accordance with the following criteria.
A: The difference between the average image densities was less than 0.1.
B: The difference between the average image densities was 0.1 to less than 0.15.
C: The difference between the average image densities was 0.15 to less than 0.2.
D: The difference between the average image densities was 0.2 to less than 0.3.
E: The difference between the average image densities was 0.3 to less than 0.4.
F: The difference between the average image densities was 0.4 to less than 0.5.

### Example 1

The photosensitive member 1 was mounted on a process cartridge configured so as to have the counter configuration and satisfy R=1.25, and the above-mentioned evaluations were performed. The obtained results are shown in Table 6 together with the value of the total sum from i=1 to i=n of (Rᵢ/ρᵢ). The total sum from i=1 to i=n of (Rᵢ/ρᵢ) was calculated from the relationship between the relative ratio of the (meth)acrylic compound, and the volume resistivity ρᵢ [Ω·cm] and volume ratio of the metal oxide particles in the surface layer of the photosensitive member 1 shown in Table 1-1, Table 1-2, and Table 2.

In Table 6, E(Rᵢ/ρᵢ) represents the total sum from i=1 to i=n of (Rᵢ/ρᵢ). In addition, the configuration “developing roller/toner-supplying roller” represents a configuration concerning an orientation between the movement direction of the surface of the developing roller and the movement direction of the surface of the toner-supplying roller at a contact portion between the developing roller and the toner-supplying roller.

### Examples 2 to 41 and Comparative Examples 1 to 6

The evaluations of each of Examples 2 to 41 and Comparative Examples 1 to 6 were performed in the same manner as in Example 1 except that in Example 1, the photosensitive member to be used and the configuration of the process cartridge to be used were changed as shown in Table 6. The results are shown in Table 6.

TABLE 6

| | | | | Configuration | | |
|---|---|---|---|---|---|---|
| | | | | “developing | Solid density | HT density |
| Example | Photosensitive | | | roller/toner-supplying | reduction | reduction |
| No. | member No. | Σ(Rᵢ/ρᵢ) | R | roller” | rank | rank |
| Example 1 | 1 | 1.6 × 10⁻¹ | 1.25 | Counter | A | A |
| Example 2 | 2 | 8.3 × 10⁻³ | 1.25 | Counter | A | B |
| Example 3 | 3 | 8.2 × 10⁻² | 1.25 | Counter | A | A |
| Example 4 | 4 | 4.0 × 10⁻¹ | 1.25 | Counter | A | A |
| Example 5 | 5 | 3.4 × 10⁻⁶ | 1.25 | Counter | A | C |
| Example 6 | 6 | 8.8 × 10⁻⁶ | 1.25 | Counter | A | C |
| Example 7 | 7 | 4.9 × 10⁻¹¹ | 1.25 | Counter | B | D |
| Example 8 | 8 | 1.3 × 10⁻¹⁰ | 1.25 | Counter | A | C |
| Example 9 | 9 | 2.3 × 10⁻¹¹ | 1.25 | Counter | B | D |
| Example 10 | 10 | 5.9 × 10⁻¹¹ | 1.25 | Counter | B | D |
| Example 11 | 11 | 3.0 × 10⁻¹⁰ | 1.25 | Counter | A | C |
| Example 12 | 12 | 7.5 × 10⁻¹⁰ | 1.25 | Counter | A | C |
| Example 13 | 13 | 1.1 × 10⁻¹⁴ | 1.25 | Counter | B | D |
| Example 14 | 14 | 2.8 × 10⁻¹⁴ | 1.25 | Counter | B | D |
| Example 15 | 15 | 2.3 × 10⁻¹⁶ | 1.25 | Counter | B | D |
| Example 16 | 16 | 5.9 × 10⁻¹⁶ | 1.25 | Counter | B | D |
| Example 17 | 17 | 7.9 × 10⁻² | 1.25 | Counter | A | A |
| Example 18 | 18 | 7.9 × 10⁻² | 1.25 | Counter | A | A |
| Example 19 | 19 | 7.9 × 10⁻² | 1.25 | Counter | A | A |
| Example 20 | 20 | 1.8 × 10⁻⁶ | 1.25 | Counter | A | C |
| Example 21 | 21 | 1.8 × 10⁻⁶ | 1.25 | Counter | A | C |
| Example 22 | 22 | 1.8 × 10⁻⁶ | 1.25 | Counter | A | C |
| Example 23 | 23 | 7.9 × 10⁻² | 1.25 | Counter | A | A |
| Example 24 | 24 | 1.8 × 10⁻⁶ | 1.25 | Counter | A | C |
| Example 25 | 25 | 7.9 × 10⁻² | 1.25 | Counter | A | A |
| Example 26 | 26 | 1.6 × 10⁻¹ | 1.25 | Counter | A | A |
| Example 27 | 27 | 1.6 × 10⁻¹ | 1.25 | Counter | A | A |
| Example 28 | 28 | 1.6 × 10⁻¹ | 1.25 | Counter | A | A |
| Example 29 | 29 | 1.6 × 10⁻¹ | 1.25 | Counter | A | B |
| Example 30 | 30 | 1.6 × 10⁻¹ | 1.25 | Counter | A | A |
| Example 31 | 31 | 1.6 × 10⁻¹ | 1.25 | Counter | A | A |
| Example 32 | 32 | 1.6 × 10⁻¹ | 1.25 | Counter | A | D |
| Example 33 | 33 | 1.6 × 10⁻¹ | 1.25 | Counter | A | D |
| Example 34 | 34 | 1.6 × 10⁻¹ | 1.25 | Counter | A | D |
| Example 35 | 35 | 1.6 × 10⁻¹ | 1.25 | Counter | A | B |
| Example 36 | 36 | 1.6 × 10⁻¹ | 1.25 | Counter | A | D |
| Example 37 | 37 | 1.6 × 10⁻¹ | 1.25 | Counter | A | B |
| Example 38 | 38 | 1.6 × 10⁻¹ | 1.25 | Counter | A | A |
| Example 39 | 1 | 1.6 × 10⁻¹ | 1.40 | Counter | B | A |
| Example 40 | 1 | 1.6 × 10⁻¹ | 1.50 | Counter | C | A |
| Example 41 | 39 | 1.1 × 10⁻¹⁴ | 1.50 | Counter | C | D |
| Comparative Example 1 | 40 | 0 | 1.25 | Counter | D | F |
| Comparative Example 2 | 44 | 8.3 × 10⁻³ | 1.25 | Counter | D (*) | E (*) |
| Comparative Example 3 | 41 | 8.2 × 10⁻³ | 1.15 | Counter | E | E |
| Comparative Example 4 | 42 | 7.9 × 10⁻³ | 1.60 | Counter | D | E |
| Comparative Example 5 | 43 | 8.2 × 10⁻³ | 1.25 | With | E | F |
| Comparative Example 6 | 44 | 0 | 1.15 | With | E (*) | F (*) |

(*) Result obtained from an average from the 9996th sheet to the 10,000th sheet because the number of sheets was not able to achieve 100,000 sheets

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212292, filed Dec. 15, 2023, which is hereby incorporated by reference herein in its entirety.

What is claimed is:

1. A process cartridge being detachably attachable onto a main body of an electrophotographic apparatus,
the process cartridge comprising:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that
a movement direction of a surface of the developing roller and a movement direction of a surface of the toner-supplying roller at a time of operation are opposite to each other at a contact position between the developing roller and the toner-supplying roller, and
the developing roller and the toner-supplying roller are rotated while R represented by formula (E1) satisfies 1.2≤R≤1.5:
$$R = {V}_{RS} / {V}_{D} \qquad ( E1 )$$
in the formula (E1),
V_{RS} represents an absolute value of a peripheral velocity (m/s) of the toner-suppling roller, and
V_{D} represents an absolute value of a peripheral velocity (m/s) of the developing roller,
wherein the electrophotographic photosensitive member includes a surface layer that is a polymerized film of a composition containing at least one kind of (meth)acrylic compound selected from the group consisting of a (meth)acrylic monomer and a (meth)acrylic oligomer, and
wherein the surface layer contains a metal oxide particle.

2. The process cartridge according to claim 1, wherein the metal oxide particle includes at least any one kind of metal oxide particle selected from the group consisting of an indium tin oxide particle, a tin oxide particle, a titanium oxide particle, a zinc oxide particle, and an aluminum oxide particle.

3. The process cartridge according to claim 1, wherein, when n kinds of the metal oxide particle are each represented by a metal oxide particle Aᵢ, a volume resistivity of the metal oxide particle Aᵢ is represented by ρᵢ (Ω·cm), and a volume content of the metal oxide particle Aᵢ in the surface layer with respect to an entirety of the surface layer is represented by Rᵢ (%), formula (E2) is satisfied:
$${10}^{- 10} < {\sum }_{i = 1}^{n} {R}_{i} / {ρ}_{i} < {10}^{1} , \qquad ( E2 )$$
where n represents an integer of 1 or more, and
where i represents an integer of 1 to n.

4. The process cartridge according to claim 3, wherein formula (E3) is satisfied
$${10}^{- 2} < {\sum }_{i = 1}^{n} {R}_{i} / {ρ}_{i} < {10}^{1} . \qquad ( E3 )$$

5. The process cartridge according to claim 1, wherein the metal oxide particle includes a metal oxide particle having a volume resistivity of 10³ (Ω·cm) or less.

6. The process cartridge according to claim 1, wherein the metal oxide particle includes an indium tin oxide particle.

7. The process cartridge according to claim 1, wherein the (meth)acrylic compound includes at least one kind of (meth)acrylic compound that is trifunctional or more selected from the group consisting of a (meth)acrylic monomer that is trifunctional or more and a (meth)acrylic oligomer that is trifunctional or more.

8. The process cartridge according to claim 7, wherein the (meth)acrylic compound includes at least one kind of (meth)acrylic compound that is hexafunctional selected from the group consisting of a (meth)acrylic monomer that is hexafunctional and a (meth)acrylic oligomer that is hexafunctional.

9. The process cartridge according to claim 1, wherein the surface layer is free of an organic compound having a charge transporting function.

10. The process cartridge according to claim 1, further comprising:
a driving force-receiving portion configured to receive a driving force for driving the toner-supplying roller;
a first driving force-transmitting portion configured to transmit the driving force received by the driving force-receiving portion to the toner-supplying roller; and
a second driving force-transmitting portion configured to transmit a driving force generated by drive of the toner-supplying roller to the developing roller.

11. The process cartridge according to claim 10,
wherein the second driving force-transmitting portion includes a third driving force-transmitting portion, a fourth driving force-transmitting portion, and a fifth driving force-transmitting portion,
wherein the third driving force-transmitting portion is arranged in an end portion of a shaft body of the toner-supplying roller, and is configured to transmit the driving force generated by the drive of the toner-supplying roller to the fourth driving force-transmitting portion,
wherein the fourth driving force-transmitting portion is configured to transmit a driving force to the fifth driving force-transmitting portion by being driven with the driving force received from the third driving force-transmitting portion, and
wherein the fifth driving force-transmitting portion is arranged in an end portion of a mandrel of the developing roller, and is configured to receive the driving force from the fourth driving force-transmitting portion to drive the developing roller.

12. The process cartridge according to claim 10, wherein when a radius of the developing roller is represented by r_{D} (mm), a radius of the toner-supplying roller is represented by r_{RS} (mm), and λ represents a value represented by the following formula (E4), the toner-supplying roller, the second driving force-transmitting portion, and the developing roller are driven to be coupled so that the following formula (E5) is satisfied:
$$λ = {ω}_{RS} / {ω}_{D} \qquad ( E4 )$$
in the formula (E4), ω_{RS} represents a rotational angular velocity (rad/s) of the toner-supplying roller, and ω_{D} represents a rotational angular velocity (rad/s) of the developing roller
$$1.2 \leq λ \times {r}_{RS} / {r}_{D} \leq 1.5 . \qquad ( E5 )$$

13. The process cartridge according to claim 1, wherein the R satisfies 1.2≤R≤1.3.

14. An electrophotographic apparatus comprising a process cartridge being detachably attachable onto a main body of the electrophotographic apparatus,
the process cartridge including:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that
a movement direction of a surface of the developing roller and a movement direction of a surface of the toner-supplying roller at a time of operation are opposite to each other at a contact position between the developing roller and the toner-supplying roller, and
the developing roller and the toner-supplying roller are rotated while R represented by formula (E1) satisfies 1.2≤R≤1.5.
$$R = {V}_{RS} / {V}_{D} \qquad ( E1 )$$
in the formula (E1),
V_{RS} represents an absolute value of a peripheral velocity (m/s) of the toner-suppling roller, and
V_{D} represents an absolute value of a peripheral velocity (m/s) of the developing roller,
wherein the electrophotographic photosensitive member includes a surface layer that is a polymerized film of a composition containing at least one kind of (meth)acrylic compound selected from the group consisting of a (meth)acrylic monomer and a (meth)acrylic oligomer, and
wherein the surface layer contains a metal oxide particle.
